(19) United States
(12) Patent Application Publication
(10) Pub. No.: US 2026/0277283 A1
(43) Pub. Date: Sep. 17, 2026

(54) VERTICALLY INTEGRATED VOLTAGE REGULATOR WITH POWER STAGE CHIPS HAVING MIRRORED FOOTPRINTS AND/OR WITH ASYMMETRIC INDUCTOR STRUCTURE

(71) Applicants: Advanced Micro Devices, Inc., Santa Clara, CA (US); ATI Technologies ULC, Markham (CA)

(72) Inventors: Shiguo Luo, Austin, TX (US); William F Harris, Austin, TX (US); Eric D Meyer, Markham (CA)

(73) Assignees: Advanced Micro Devices, Inc., Santa Clara, CA (US); ATI Technologies ULC, Markham (CA)

(21) Appl. No.: 19/077,426

(22) Filed: Mar. 12, 2025

(51) Int. Cl. G06F 1/18

(52) U.S. Cl. CPC G06F 1/189

(57) ABSTRACT

A voltage regulator assembly can include a power stage chip and an inductive component coupled to the power stage chip. A footprint of the power stage chip can be bonded to a surface of a printed circuit board. The inductive component can include at least one coil, wherein a first portion of the coil is disposed on or over a surface of the power stage chip. The printed circuit board, the power stage chip, and the first portion of the coil can be arranged in a stack. The voltage regulator assembly can be configured to provide one or more power supply signals via the inductive component.

### BACKGROUND

Voltage regulators (VRs) include power circuits that regulate the voltages of electrical signals (e.g., power supply signals). A switched mode voltage regulator(“switching regulator” or “switched mode regulator”) regulates the power supply voltage by switching one or more switches (e.g., transistors) on and off, with the duty cycles of the switches determining how much charge is transferred from the power supply to the load. Switching regulators can be highly efficient and are often used in computer systems. Voltage regulator power circuits having two or more phase circuits (PCs) can be referred to as multi-phase VR power circuits.

The physical dimensions of a surface of a device (e.g., a VR power circuit) that attaches to a surface of a printed circuit board (PCB) can be referred to as the device's “footprint.” In context, a reference to a device's footprint can refer to the length and width of the footprint, the surface area of the footprint, or a combination of length, width, and surface area.

### BRIEF DESCRIPTION OF THE FIGURES

The accompanying drawings illustrate a number of example implementations and are a part of the specification. Together with the following description, these drawings demonstrate and explain various principles of the present disclosure.

FIG. 1 is a block diagram of an example voltage regulator with one or more power circuits each having one or more phase circuits.

FIG. 2 is a block diagram of an example power stage (Pstage) of a phase circuit of a voltage regulator.

FIG. 3A shows top views of example footprint of two Pstage packages.

FIG. 3B is a schematic illustration of an example reduced-footprint VR device.

FIG. 4 is a block diagram of an example computer system with supply voltages of one or more components regulated by an example vertical voltage regulator assembly.

FIG. 5A is a top view of an example footprint of an example first power stage chip of a vertical voltage regulator assembly.

FIG. 5B is a top view of an example footprint of an example second power stage chip, which mirrors the footprint of FIG. 5A.

FIG. 6A is a side view of an example vertical voltage regulator assembly with stacked power stages in a single-phase configuration.

FIG. 6B is a side view of an example vertical voltage regulator assembly with stacked power stages in a dual-phase configuration.

FIG. 7A is a side view of an example vertical voltage regulator assembly with vertically-integrated power stage chips and an inductive component in a single-phase configuration.

FIG. 7B is a side view of an example vertical voltage regulator assembly with vertically-integrated power stage chips and an inductive component in a dual-phase configuration.

FIG. 8A is a block diagram of an example system including an example dual-stage voltage regulator which includes a vertical voltage regulator assembly.

FIG. 8B is a block diagram of an example vertically integrated VR assembly.

FIG. 8C is a block diagram of an example system including an example vertical VR assembly disposed under an integrated circuit package.

FIG. 9 is a flow diagram of an example method for manufacturing a vertical voltage regulator assembly.

Throughout the drawings, identical reference characters and descriptions indicate similar, but not necessarily identical, elements. While the examples described herein are susceptible to various modifications and alternative forms, specific implementations have been shown by way of example in the drawings and will be described in detail herein. However, the example implementations described herein are not intended to be limited to the particular forms disclosed. Rather, the present disclosure covers all modifications, equivalents, and alternatives falling within the scope of the appended claims.

### DETAILED DESCRIPTION OF EXAMPLE IMPLEMENTATIONS

The present disclosure describes examples of vertical voltage regulator (VR) assemblies, VR devices including one or more vertical VR assemblies, systems including one or more vertical VR assemblies, and methods for manufacturing vertical VR assemblies. In some examples, a vertical VR assembly (e.g., a VR assembly with components vertically-integrated components) exhibits greater power density and has a smaller footprint than a lateral VR assembly (e.g., a VR assembly with components situated laterally on a printed circuit board) having comparable performance capabilities.

### Some Examples of Voltage Regulators

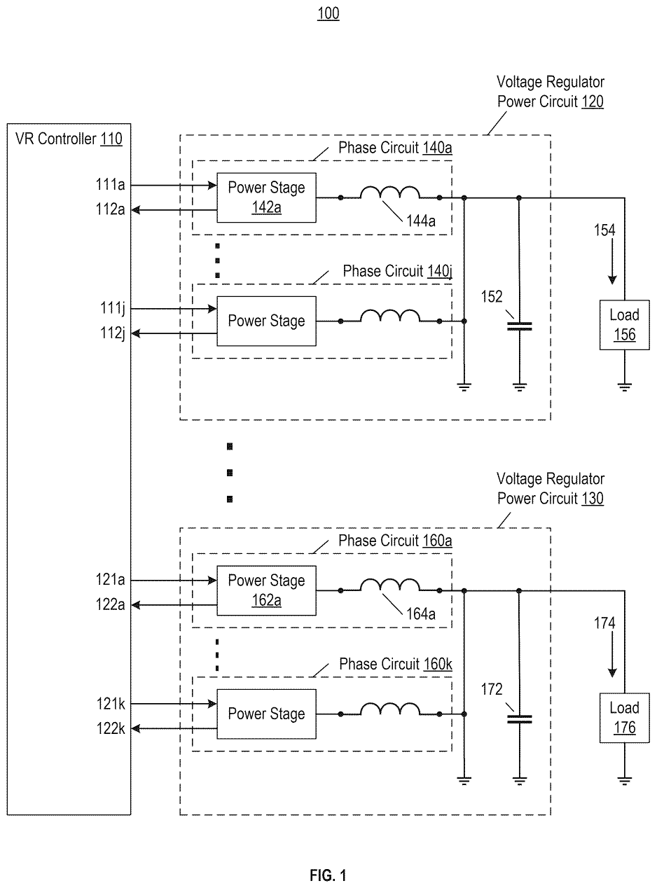

FIG. 1 illustrates an example of a voltage regulator 100. In some examples, the voltage regulator 100 includes a VR controller 110 and one or more VR power circuits 120, 130. Each VR power circuit can be configured to provide a regulated power supply signal to a load (e.g., a rail load). Each VR power circuit can include one or more phase circuits, each of which can provide a phase of the power circuit's regulated power supply signal to the power circuit's rail load. In some examples, the VR controller 110 includes multi-phase control circuitry capable of controlling multiple phase circuits of a VR power circuit to provide multi-phase power supply signals to a rail load. In some examples, the VR controller 110 includes multi-rail control circuitry capable of controlling multiple VR power circuits to support multiple rail loads. A VR controller with multi-rail and multi-phase control circuitry can be referred to as a multi-rail, multi-phase VR controller.

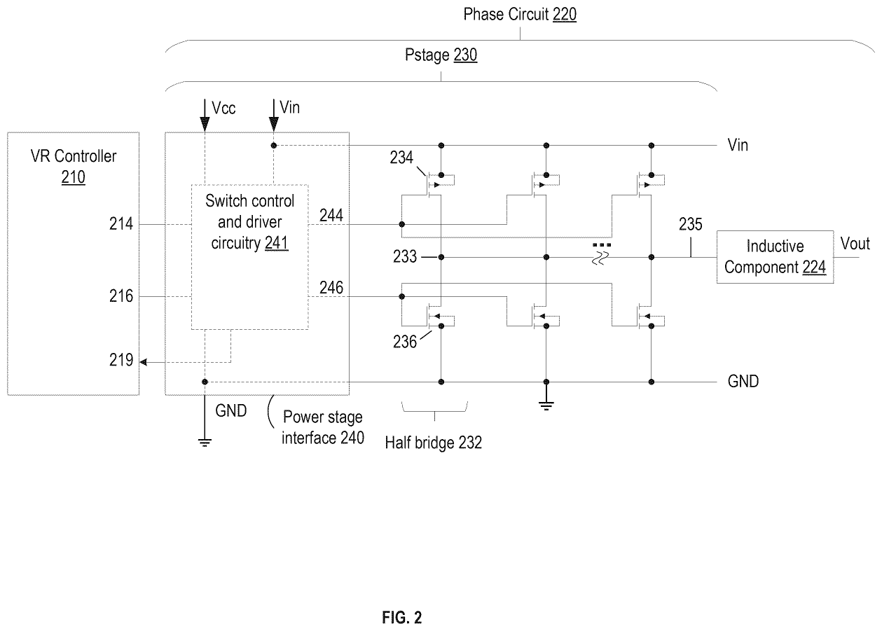

Voltage regulator power circuit 120 can provide a regulated power supply signal 154 to a load 156 (e.g., rail load). Voltage regulator power circuit 120 can include one or more phase circuits (e.g., phase circuits 140a-140j). A phase circuit 140a can include a power stage 142a and an inductive component 144a. The power stage 142a can include one or more switches (e.g., MOSFETs or other transistors) and switch control and driver circuitry operable to control the amount of power (or current) provided by the phase circuit 140a to the load 156 by selectively activating and deactivating the switches. The power stage 142a can have any suitable topology. Some non-limiting examples of power stages 142a are described herein with reference to FIG. 2.

A phase circuit 140a can be configured to provide a current of any suitable amplitude to the load 156. For example, a phase circuit 140a can be configured to provide a current having a relatively low amplitude less than a first amplitude threshold (e.g., 5 A, 3 A, 2 A, etc.), a current having a moderate amplitude (e.g., between the first amplitude threshold and a second amplitude threshold, e.g., 12 A), or a current having a high amplitude (e.g., greater than the second amplitude threshold and less than a third amplitude threshold, e.g., 24 A, 30 A, 35 A, etc.). The inductive component 144a can have any suitable inductance. The inductive component 144a can includes a non-linear inductor and/or a linear inductor. In some examples, the inductive component 144a includes more than one inductor. The remaining phase circuits can be structurally similar, though not necessarily identical, to phase circuit 140a.

In some examples, the VR controller 110 provides one or more control signals 111a to control the operation of the phase circuit 140a. In some examples, the phase circuit 140a provides one or more feedback signals 112a to the VR controller 110. Such feedback signals can indicate the values of one or more parameters of the phase circuit, and the VR controller 110 can set or adjust the control signals 111a provided to the phase circuit 140a based on the feedback signals 112a received from the phase circuit 140a.

In addition to one or more phase circuits, voltage regulator power circuit 120 can include a capacitive component 152 (e.g., a capacitor). The inductive component of each phase circuit can be coupled between the phase circuit's power stage and a terminal of the capacitive component 152. The combination of each phase circuit's inductive component and the VR power circuit's capacitive component 152 can form a filter that reduces ripple voltage and/or ripple current of the regulated supply signal provided by the respective phase circuit to the load 156. In addition, the combination of each phase circuit and the VR power circuit's capacitive component 152 can form a DC-to-DC converter (e.g., a buck converter, boost converter, buck-boost converter, cuk converter, etc.). The DC-to-DC converter can be configured to operate in a continuous mode and/or in a discontinuous mode.

In the example of FIG. 1, the VR power circuit 120 includes J phase circuits 140a-140j, the VR controller 110 provides control signals 111a-111j to the respective phase circuits 140a-140j, and the phase circuits 140a-140j provide feedback signals 112a-112j to the VR controller 110. The VR power circuit 120 can include any suitable number of phase circuits.

In the example of FIG. 1, the voltage regulator includes a second VR power circuit 130. The VR power circuit 130 can includes one or more phase circuits 160a-160k and a capacitive component 172 (e.g., a capacitor). Each phase circuit can include a power stage (e.g., power stage 162a) and an inductive component (e.g., inductive component 164a). The VR power circuit can provide a power supply signal 174 with a regulated voltage to a load 176 (e.g., rail load). In the example of FIG. 1, the VR controller 110 provides control signals 121a-121k to the respective phase circuits 160a-160k, and the phase circuits 140a-140j provide feedback signals 122a-122k to the VR controller 110. The VR power circuit 130 can include any suitable number of phase circuits. The voltage regulator 100 can include any suitable number of VR power circuits.

FIG. 2 illustrates an example power stage 230 (Pstage 230) of a phase circuit 220 of a voltage regulator. In some examples, the phase circuit 220 also includes an inductive component 224. Other implementations of the power stage 230 are possible. In some examples, a power stage (“Pstage”) includes one or more high-side switches 234 (e.g., p-type MOSFETs) configured to couple the switch node 235 of the power stage to a supply voltage rail (Vin) (thereby delivering power and/or current to the switch node 235), and one or more low-side switches 236 (e.g., n-type MOSFETs) configured to couple the switch node 235 of the power stage to ground (GND) (thereby delivering power and/or current from the switch node 235 to ground). In some examples, pairs of high-side switches 234 and low-side switches 236 are connected in a half bridge configuration, with the conducting path (e.g., channel) of the high-side switch 234 coupled between the supply voltage rail (Vin) and the half bridge's switch node 233, and the conducting path (e.g., channel) of the low-side switch 236 coupled between the half bridge's switch node 233 and ground (GND). The power stage 230 can include one or more half bridges 232, with their switch nodes 233 coupled to each other and to the switch node 235 of the Pstage. Other arrangements of the high-and low-side switches are possible.

In some examples, the power stage 230 further includes power stage interface 240. In some examples, the power stage interface 240 includes switch control and driver circuitry 241. In some examples, the power stage interface 240 receives power supply signals (e.g., supply voltage Vin, power supply bias voltage Vcc, and ground reference GND) from a power supply, and provides those power supply signals to the switch control and driver circuitry 241 and to the switches (234, 236) of the power stage 230. In some examples, the power stage interface 240 receives control signals (214, 216) from the VR controller 210. In some examples, the control signals (214, 216) indicate the amount of power (or current) to be delivered to the power stage's switch node 235, or delivered from the power stage's switch node 235 to ground. In some examples, the control signals (214, 216) indicate the duty cycles at which the switches (234, 236) of the power stage 230 are to be operated. The power stage interface 240 can provide the control signals (214, 216) as inputs to the switch control and driver circuitry 241. In some examples, the switch control and driver circuitry 241 generates control signals (244, 246) for the power stage 230 based on the control signals (214, 216) provided by the VR controller 210. In some examples, the control signals 244 (e.g., pulse-width modulated (PWM) control signals) are provided to the control terminals (e.g., gates) of the high-side switches 234, such that the control signals 244 determine the duty cycles of the high-side switches 234. In some examples, the control signals 246 (e.g., pulse-width modulated (PWM) control signals) are provided to the control terminals (e.g., gates) of the low-side switches 236, such that the control signals 246 determine the duty cycles of the low-side switches 236.

In some examples, the power stage interface 240 provides one or more feedback signals 219 to the VR controller 210. The feedback signal(s) can indicate the values of one or more parameters of the power stage 230. Some non-limiting examples of such parameters can include a temperature of the power stage 230, voltages and/or currents of one or more signals within the power stage 230 or produced by the power stage 230 (e.g., the amplitude of the current delivered to switch node 235, etc. The feedback signals can be provided by the switch control and driver circuitry 241. In some examples, the switch control and driver circuitry 241 includes current sensing circuitry that senses the amplitudes of one or more currents in the power stage 230 (e.g., the current at switch node 235, the currents flowing through each of the half bridges 232, etc.) and provides the feedback signal(s) 219 indicating the amplitudes of the sensed current(s). In some examples, the power stage interface 240 includes a temperature sensor, which provides a feedback signal 219 indicating the temperature of the power stage 230.

### Overview of Some Aspects of Vertical Voltage Regulator Assemblies

The footprints of voltage regulator power circuits can be large, particularly in comparison to the footprints of the devices to which they supply regulated voltage signals, or as a proportion of the total surface area of the PCBs to which the VR power circuits are attached. When the components of a VR power circuit are laterally laid out (e.g., laterally situated and connected on the surface a PCB), the footprint of each phase circuit can be significant, and the footprint area of N phase circuits can be roughly N times the footprint area of a single phase circuit. Likewise, the footprints of individual power stages can be large, and when power stages are laterally laid out on the surface of a PCB, the footprint area of N phase circuits can be roughly N times footprint area of a single power stage.

The large footprints of VR power circuits with lateral layouts (“lateral VR power circuits”) can be problematic for at least two reasons. First, lateral VR power circuits generally have low power density. However, for many classes of computers (e.g., servers, laptops, gaming PCs, etc.), high power density is desired to meet the ever-growing demand for power, which is largely driven by certain types of processing devices (e.g., CPUs, GPUs, XPUs, etc.) and certain types of workloads (e.g., machine-learning (ML), artificial intelligence (AI), gaming, or other heavy workloads). Second, the large footprints of lateral VR power circuits make it difficult to place them near their loads (e.g., processing devices) on computer motherboards. Consequently, power delivery losses during transmission of power from the lateral VR power circuits to the loads can be significant, yielding low power efficiency and increased operating expenses.

Thus, VR power circuits with smaller footprints are needed, particularly for laptops (in which PCB area is scarce and power inefficiency limits battery life) and high-performance computer systems (e.g., servers) running heavy workloads (e.g., AI, ML, or gaming workloads), but also for other types of devices. Absent improvements over the power density of lateral VR power circuits, the power density of voltage regulators is likely to become a bottleneck on the performance of future computer systems, especially high-performance systems running AI-centric workloads. Likewise, voltage regulators with increased power efficiency are needed. In high-performance computer systems, a single XPU running a heavy workload can draw currents as high as 1,000 amps, 2,000 amps, or even 4,000 amps. With such large currents, even marginal improvements in the power efficiency of the VR power circuit can translate to significant reductions in operating cost.

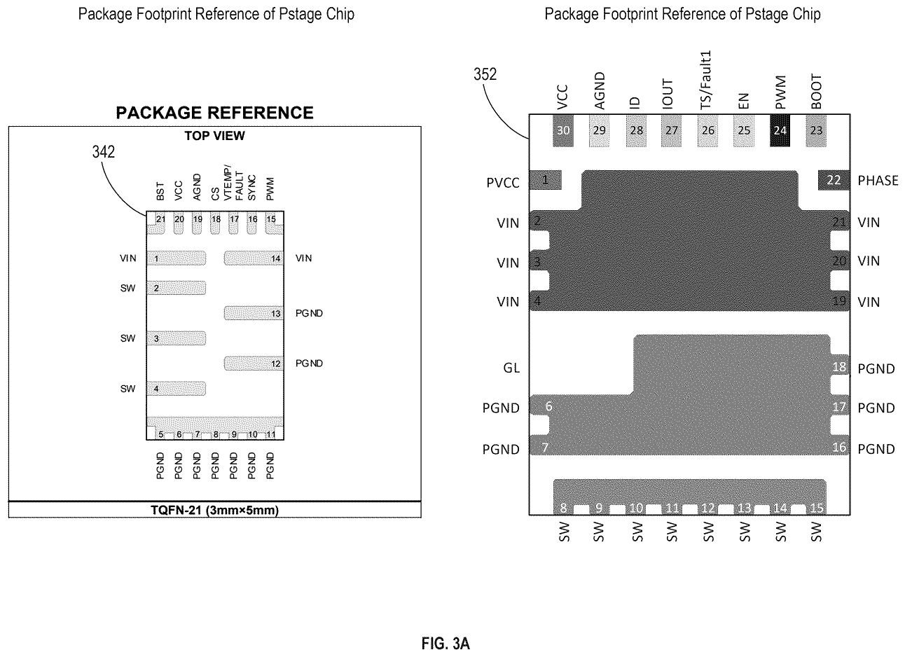

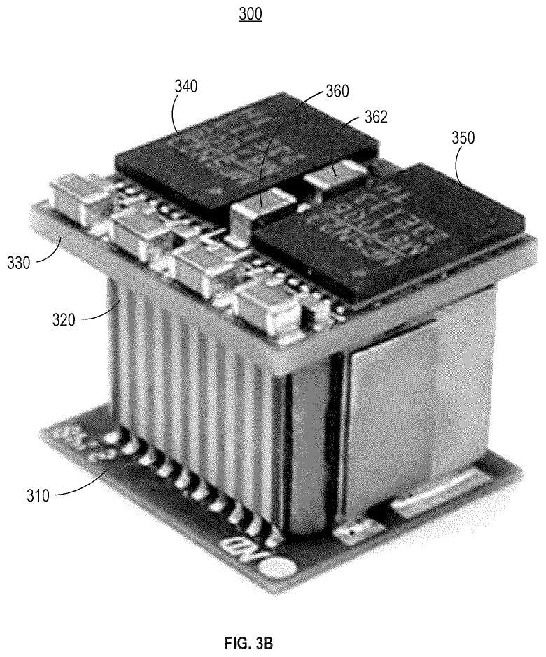

One option for reducing the footprint of a VR power circuit is to vertically integrate the power circuit's power stages. However, existing power stage packages (also referred to as “Pstage packages” or “Pstage chips”) are generally unsuitable for vertical integration. For example, the footprints of existing Pstage chips do not exhibit mirror symmetry. FIG. 3A shows examples of the footprints (342, 352) of two Pstage chips. As FIG. 3A shows, the footprints (342, 352) do not exhibit mirror symmetry at least with respect to the contacts SW (internally coupled to the Pstage's switch node), the contacts PGND (externally coupled to the power supply ground node), and the contacts VIN (configured to propagate the input power supply signal), because those contacts would not be vertically aligned if the Pstage chips were stacked vertically such that their footprints (342, 352) faced each other. Thus, if Pstage chips having the footprints (342, 352) were stacked vertically with their footprints facing each other, providing efficient electrical and thermal couplings between the corresponding contacts of the two chips would be difficult.

Another option for reducing the footprint of VR power circuits is to maintain the lateral layout of power stages (Pstages) but stack the Pstages vertically on top of an inductor. An example of such a reduced-footprint VR device 300 is shown in FIG. 3B. The reduced-footprint VR device 300 can include a first PCB 310 (or a portion thereof), an inductor 320 attached to the first PCB, a second PCB 330 stacked on top of the inductor, two power stage chips (340, 350) attached to the top surface of the second PCB, and one or more capacitors. In some examples, the power stage chips (340, 350) of FIG. 3B have the footprints (342, 352) shown in FIG. 3A. Each power stage chip can include a packaged, integrated power stage (e.g., power stage 230). In some examples, the reduced-footprint VR device 300 includes one or more decoupling capacitors (360, 362), which can be positioned between the power stage chips on the second PCB. In some examples, the footprint area of the reduced-footprint VR device 300 is a little more than half the footprint area of a comparable lateral VR power circuit.

In the reduced-footprint VR device 300, the placement of the power stage chips at the top of the device facilitates heat dissipation from the chips. In general, the power stages of a voltage regulator can generate significant amounts of heat, which can interfere with the VR's performance and/or damage the VR. Accordingly, the temperature of a VR device is generally regulated by a cooling system, which dissipates the heat generated by the power stages. Such cooling systems often include a thermal pad and a heat sink positioned on top of the VR device. Thus, placing the power stage chips (340, 350) of the reduced-footprint VR device 300 facilitates cooling of the chips by placing the chips directly beneath the thermal pad and heat sink.

However, the placement of the power stage chips at the top of the reduced-footprint VR device 300 has several disadvantages. First, the design uses two PCBs, which increases cost and complexity. Second, the power conversion and delivery path through the reduced-footprint VR device 300 is lengthy, running up from the bottom PCB 310 to the top PCB 330, through the power stage chips, then back down from the top PCB 330 to the bottom PCB 310 through the inductor 320. This lengthy path decreases efficiency, yielding high power loss. Third, there is little room for decoupling capacitors on the top PCB, which can make the reduced-footprint VR device more susceptible to sudden voltage fluctuations (e.g., OSC voltage spikes) and can increase stress on the switches of the Pstage chips.

One option for increasing the power efficiency of VR devices (e.g., reduced-footprint VR device 300) is to use trench power MOSFETs in the power stages. Such MOSFETs generally exhibit low on-resistance and low conduction losses, yielding high power efficiency. However, trench power MOSFETs also generally have large gates and large Miller capacitances, which tend to limit power density and switching frequency.

The present disclosure describes examples of a vertical VR assembly in which (1) at least one Pstage chip is stacked on top of another Pstage chip and/or (2) an inductive component is stacked on top of at least one Pstage chip. In some examples, an inductive component is stacked on top of a first Pstage chip, which is stacked on top of a second Pstage chip. In some examples, the footprints of the stacked Pstage chips exhibit mirror symmetry. In some examples, the vertical VR assembly reduces the footprint and increases the power density of the VR power circuit relative to a comparable lateral VR power circuit, supports high switching frequencies, and provides paths (e.g., vertical paths through the VR assembly) for efficient heat dissipation.

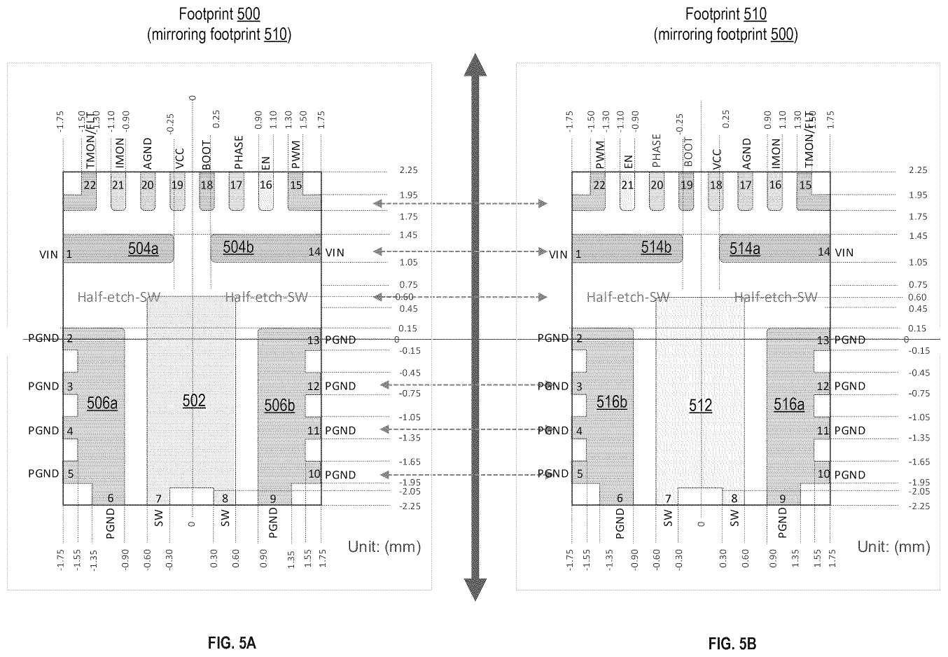

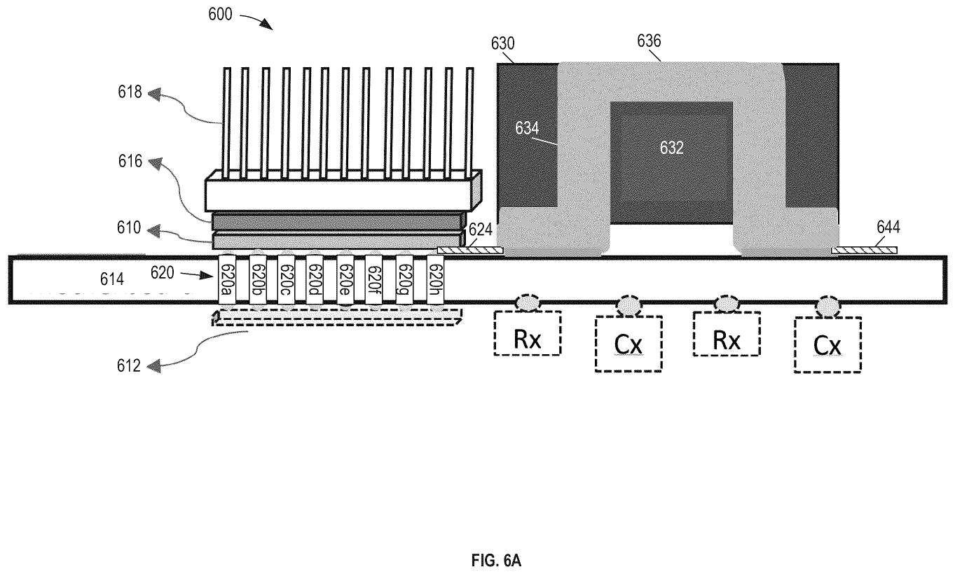

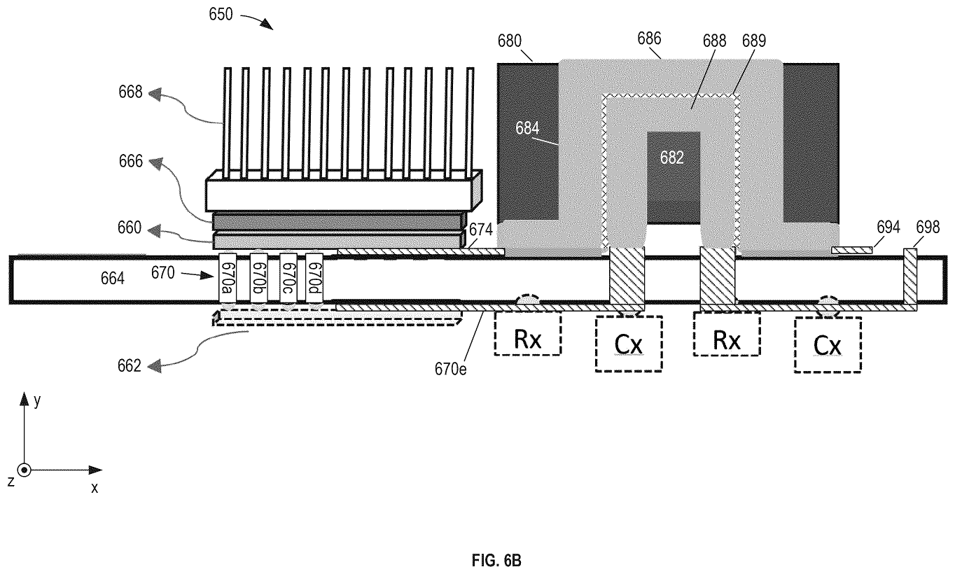

Some examples of vertical VR assemblies with stacked Pstage chips are described below with reference to FIGS. 6A-6B. In some examples, the Pstage chips are attached to opposite surfaces of a PCB, such that the footprints of the Pstage chips face each other. In some examples, the contacts (e.g., contact pads) on the footprints of the stacked Pstage chips exhibit mirror symmetry, as described below with reference to FIGS. 5A-5B. In some examples, such mirror symmetry facilitates electrical and thermal coupling between the Pstage chips through short conductors (e.g., vertical vias through the PCB to which the Pstage chips are attached). In some examples, the thermal coupling through the shared vertical vias provides an efficient thermal path whereby heat generated by the bottom Pstage chip can travel to the top Pstage chip.

Vertical VR assemblies with stacked Pstage chips can provide several advantages. In some examples, stacking the Pstage chips as illustrated in FIGS. 6A-6B can reduce the footprint of the vertical VR assembly by roughly 50% relative to the footprint of a comparable lateral VR assembly. In some examples, the smaller footprint of the vertical VR assembly provides additional free space on the system PCB and facilitates placement of the vertical VR assembly closer to its load(s) (e.g., processor(s)), which can significantly increase power efficiency and reduce power losses arising from the transfer of power from the VR to the load(s). In addition, the coupling of corresponding contacts of the Pstage chips of the vertical VR assembly through short vertical vias can further improve power efficiency, reduce power losses, and facilitate heat transfer from the bottom Pstage chip to the top Pstage chip.

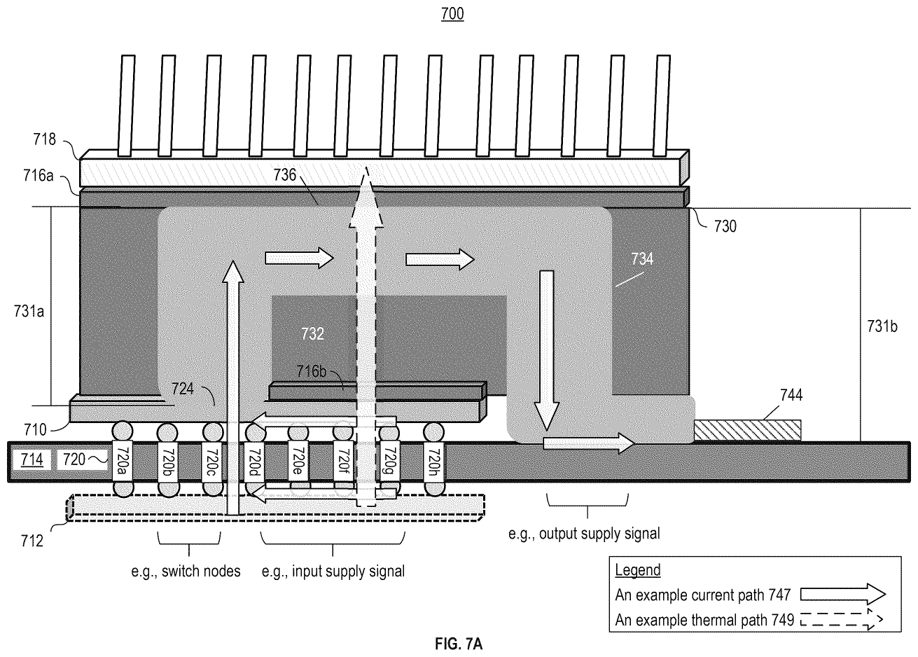

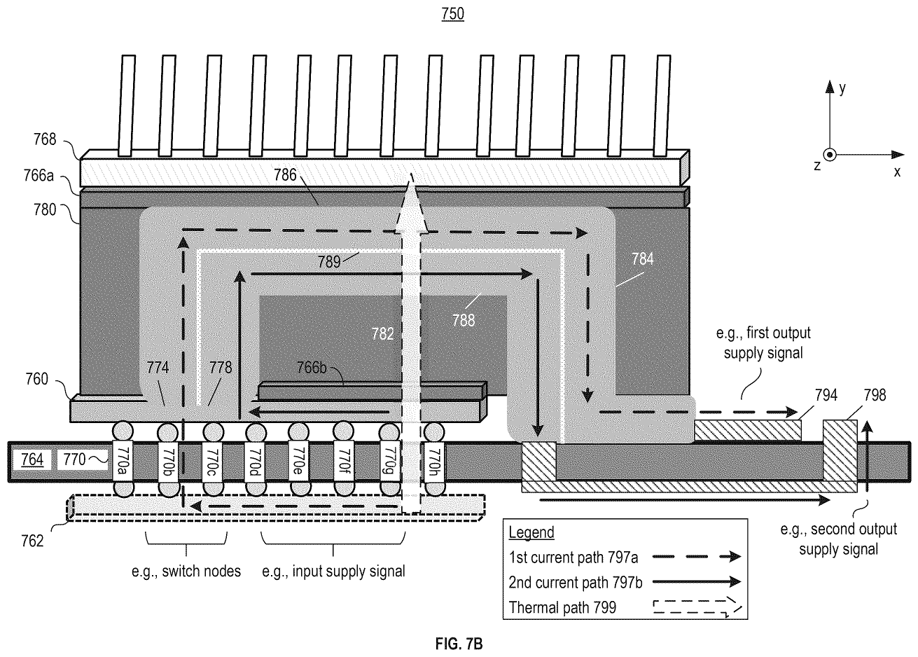

Some examples of vertical VR assemblies in which an inductive component is stacked on top of one or more Pstage chips are described below with reference to FIGS. 7A-7B. In some examples, the stacked inductive component provides a thermal path for heat generated by the Pstage chip(s) stacked below the inductive component. In some examples, the Pstage chip directly below the inductive component in the stack has a contact on a top surface of the chip (e.g., the surface opposite the chip's footprint). This contact can be internally coupled to the switch node of the power stage implemented by the Pstage chip, and can be externally coupled to a contact of the inductive component. In some examples, this contact further facilitates heat transfer from the Pstage chip(s) to the inductive component.

Vertical VR assemblies with an inductive component stacked on top of one or more Pstage chips can provide several advantages. In some examples, stacking an inductive component on top of two stacked Pstage chips reduces the footprint of the vertical VR assembly by more than 70% relative to a comparable lateral VR assembly, and/or reduces the cost of the vertical VR assembly by roughly one-third relative to a comparable lateral VR assembly. In some examples, the power delivery path within the vertical VR assembly can be shorter than the power deliver path of a comparable lateral VR assembly, yielding higher switching frequencies, greater power efficiency, and lower power losses.

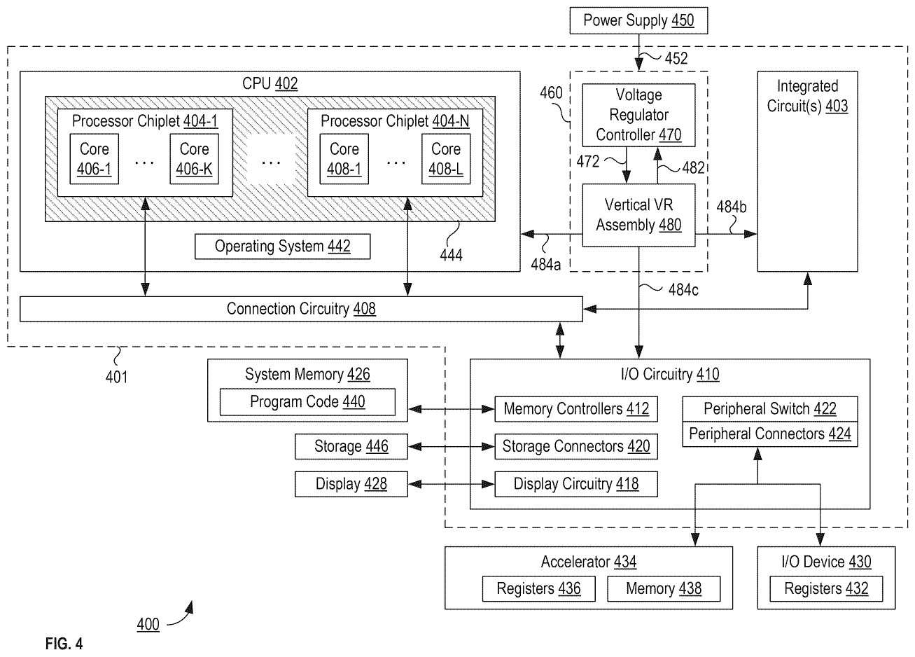

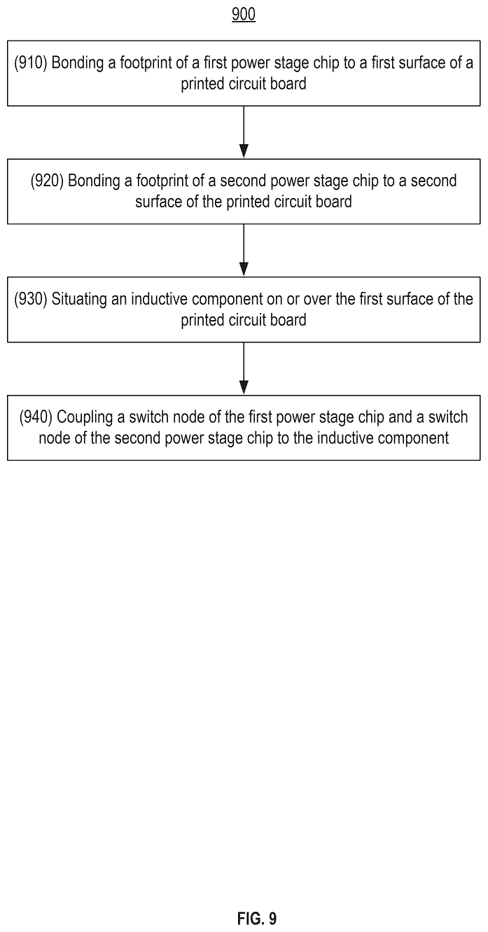

This disclosure provides, with reference to FIGS. 1-8C, detailed descriptions of example voltage regulator components and systems, including vertical VR assemblies, some aspects of which are illustrated in FIGS. 4-8C. A detailed description of a corresponding method for manufacturing vertical VR assemblies is provided in connection with FIG. 9.

In some aspects, the techniques described herein relate to a computer system including: one or more integrated circuits; and a voltage regulator assembly including a first power stage chip, a second power stage chip, and an inductive component coupled to the first and second power stage chips, wherein the first power stage chip, the second power stage chip, and a printed circuit board are arranged in a stack, wherein a footprint of the first power stage chip is bonded to a first surface of a printed circuit board, and a footprint of the second power stage chip is bonded to a second surface of the printed circuit board opposite the first surface, and wherein the voltage regulator assembly is configured to provide a power supply signal to at least one integrated circuit of the one or more integrated circuits.

In some aspects, the techniques described herein relate to a computer system, wherein the voltage regulator assembly further includes a thermal pad disposed on or over the first power stage chip and a heat sink disposed on or over the thermal pad.

In some aspects, the techniques described herein relate to a computer system, wherein one or more first contacts of the footprint of the first power stage chip are coupled to one or more respective second contacts of the footprint of the second power stage chip through one or more respective conductive couplings, wherein each of the one or more conductive couplings includes a respective through via of the printed circuit board.

In some aspects, the techniques described herein relate to a computer system, wherein the footprint of the second power stage chip is configured as a mirror reflection of the footprint of the first power stage chip.

In some aspects, the techniques described herein relate to a computer system, wherein the power supply signal is a first power supply signal, and wherein: the footprint of the first power stage chip includes at least one first contact configured to be coupled to ground, and at least one second contact configured to be coupled to a second power supply signal; and the footprint of the second power stage chip includes at least one fourth contact opposite the at least one first contact and configured to be coupled to ground and to the at least one first contact by a conductive coupling including at least one through via of the printed circuit board, and at least one fifth contact opposite the at least one second contact and configured to be coupled to the second power supply signal and to the at least one second contact by a conductive coupling including at least one through via of the printed circuit board.

In some aspects, the techniques described herein relate to a computer system, wherein the footprint of the first power stage chip includes at least one third contact coupled to a switch node of the first power stage chip, and the footprint of the second power stage chip includes at least one sixth contact opposite the at least one third contact and coupled to a switch node of the second power stage chip.

In some aspects, the techniques described herein relate to a computer system, wherein the inductive component is disposed on or over the first surface of the printed circuit board and situated laterally with respect to the first power stage chip.

In some aspects, the techniques described herein relate to a computer system, wherein: the inductive component includes an inductor having a terminal coupled to a switch node of the first power stage chip and to a switch node of the second power stage chip, and the voltage regulator assembly is configured to provide, to the integrated circuit via the inductor, a first phase current supplied by the first power stage chip and a second phase current supplied by the second power stage chip.

In some aspects, the techniques described herein relate to a computer system, wherein: the one or more integrated circuits include a first integrated circuit and a second integrated circuit; the inductive component includes a first coil and a second coil coupled to the first coil; a switch node of the first power stage chip is coupled to a terminal of the first coil, and the voltage regulator assembly is configured to provide, to the first integrated circuit via the first coil, a first phase current supplied by the first power stage chip; and a switch node of the second power stage chip is coupled to a terminal of the second coil, and the voltage regulator assembly is configured to provide, to the second integrated circuit via the second coil, a second phase current supplied by the second power stage chip.

In some aspects, the techniques described herein relate to a computer system, wherein the inductive component includes at least one coil, and wherein a first portion of the coil is disposed on or over a surface of the first power stage chip.

In some aspects, the techniques described herein relate to a computer system, wherein the first portion of the coil is configured to provide a thermal path for at least some heat dissipated by the first and second power stage chips.

In some aspects, the techniques described herein relate to a computer system, wherein the first portion of the coil includes a portion having an exposed surface at a top surface of the inductive component.

In some aspects, the techniques described herein relate to a computer system, wherein a second portion of the coil is bonded to the first surface of the printed circuit board and situated laterally on the printed circuit board with respect to the first power stage chip.

In some aspects, the techniques described herein relate to a computer system, wherein: the first portion of the coil includes a first terminal of the coil coupled to a contact on a lower surface of the inductive component; a switch node of the first power stage chip is coupled to a contact on a top surface of the first power stage chip, and the contact on the lower surface of the inductive component is coupled to the contact on the top surface of the first power stage chip.

In some aspects, the techniques described herein relate to a computer system, wherein the voltage regulator assembly is configured to provide, to the at least one integrated circuit via the coil, a first phase current supplied by the first power stage chip and a second phase current supplied by the second power stage chip.

In some aspects, the techniques described herein relate to a computer system, wherein: the one or more integrated circuits include a first integrated circuit and a second integrated circuit; the inductive component includes a first coil and a second coil coupled to the first coil; the voltage regulator assembly is configured to provide, to the first integrated circuit via the first coil, a first phase current supplied by the first power stage chip; and the voltage regulator assembly is configured to provide, to the second integrated circuit via the second coil, a second phase current supplied by the second power stage chip.

In some aspects, the techniques described herein relate to a computer system, wherein a structure of the inductive component is asymmetric.

In some aspects, the techniques described herein relate to a computer system, further including a motherboard, wherein the printed circuit board arranged in the stack includes a portion of the motherboard.

In some aspects, the techniques described herein relate to a computer system, wherein the at least one integrated circuit includes a processor disposed on the motherboard, and wherein a distance from the voltage regulator assembly to the processor is less than 50 mm.

In some aspects, the techniques described herein relate to a computer system, wherein the voltage regulator assembly is a first voltage regulator assembly, wherein the power supply signal is a first power supply signal, and wherein the computer system further includes a second voltage regulator assembly disposed on the motherboard and configured to provide a second power supply signal to the first voltage regulator assembly.

In some aspects, the techniques described herein relate to a computer system, further including a motherboard, wherein the at least one integrated circuit includes a processor disposed on a first surface of the motherboard, and wherein the voltage regulator assembly is disposed on a second surface of the motherboard opposite the processor.

In some aspects, the techniques described herein relate to a computer system, wherein the voltage regulator assembly further includes a plurality of decoupling capacitors disposed on the printed circuit board and shared by the first and second power stage chips.

In some aspects, the techniques described herein relate to a voltage regulator assembly including: a first power stage chip; a second power stage chip; and an inductive component coupled to the first and second power stage chips, wherein the first power stage chip, the second power stage chip, and a printed circuit board are arranged in a stack, wherein a footprint of the first power stage chip is bonded to a first surface of a printed circuit board, and a footprint of the second power stage chip is bonded to a second surface of the printed circuit board opposite the first surface, and wherein the inductive component is configured to provide one or more power supply signals.

In some aspects, the techniques described herein relate to a voltage regulator assembly, wherein the footprint of the second power stage chip is configured as a mirror reflection of the footprint of the first power stage chip.

In some aspects, the techniques described herein relate to a voltage regulator assembly, wherein: the inductive component includes an inductor having a terminal coupled to a switch node of the first power stage chip and to a switch node of the second power stage chip, and the voltage regulator assembly is configured to provide, via the inductor, a first phase current supplied by the first power stage chip and a second phase current supplied by the second power stage chip.

In some aspects, the techniques described herein relate to a voltage regulator assembly, wherein: the inductive component includes a first coil and a second coil coupled to the first coil; a switch node of the first power stage chip is coupled to a terminal of the first coil, and the voltage regulator assembly is configured to provide, via the first coil, a first phase current supplied by the first power stage chip; and a switch node of the second power stage chip is coupled to a terminal of the second coil, and the voltage regulator assembly is configured to provide, via the second coil, a second phase current supplied by the second power stage chip.

In some aspects, the techniques described herein relate to a voltage regulator assembly, wherein the inductive component includes at least one coil, and wherein a first portion of the coil is disposed on or over a surface of the first power stage chip.

In some aspects, the techniques described herein relate to a voltage regulator assembly, wherein the first portion of the coil is configured to provide a thermal path for at least some heat dissipated by the first and second power stage chips.

In some aspects, the techniques described herein relate to a voltage regulator assembly, further including a plurality of decoupling capacitors disposed on the printed circuit board and shared by the first and second power stage chips.

In some aspects, the techniques described herein relate to a method of assembling a voltage regulator assembly, the method including: bonding a footprint of a first power stage chip to a first surface of a printed circuit board; bonding a footprint of a second power stage chip to a second surface of the printed circuit board opposite the first surface; situating an inductive component on or over the first surface of the printed circuit board; and coupling a switch node of the first power stage chip and a switch node of the second power stage chip to the inductive component, wherein the first power stage chip, the second power stage chip, and a printed circuit board are arranged in a stack, and wherein the inductive component is configured to provide one or more power supply signals of the voltage regulator assembly.

In some aspects, the techniques described herein relate to a method, further including: situating a thermal pad on or over the first power stage chip; and situating a heat sink on or over the thermal pad.

In some aspects, the techniques described herein relate to a method, further including: coupling one or more first contacts of the footprint of the first power stage chip to one or more respective second contacts of the footprint of the second power stage chip through one or more respective through via of the printed circuit board.

In some aspects, the techniques described herein relate to a method, further including: prior to the bonding of the footprint of the second power stage chip to the second surface of the printed circuit board, orienting the second power stage chip such that the footprint of the second power stage chip is configured as a mirror reflection of the footprint of the first power stage chip.

In some aspects, the techniques described herein relate to a method, wherein situating the inductive component includes situating the inductive component laterally with respect to the first power stage chip.

In some aspects, the techniques described herein relate to a method, wherein the switch node of the second power stage chip is coupled to the inductive component through a through via of the printed circuit board.

In some aspects, the techniques described herein relate to a method, wherein the inductive component includes at least one coil, and wherein situating the inductive component includes situating a first portion of the coil on or over a surface of the first power stage chip.

In some aspects, the techniques described herein relate to a method, further including bonding a second portion of the coil to the first surface of the printed circuit board.

In some aspects, the techniques described herein relate to a method, wherein the switch node of the second power stage chip is coupled to the inductive component through a through via of the printed circuit board and through a contact of the first power stage chip.

In some aspects, the techniques described herein relate to a method, wherein the printed circuit board arranged in the stack includes a portion of a motherboard of a computer system.

In some aspects, the techniques described herein relate to a method, wherein the voltage regulator assembly is a first voltage regulator assembly, wherein the power supply signal is a first power supply signal, and wherein the method further includes coupling an input terminal of the first voltage regulator assembly to an output terminal of a second voltage regulator assembly disposed on the motherboard.

In some aspects, the techniques described herein relate to a method, further including attaching the voltage regulator assembly to a second surface of a motherboard, wherein a processor is disposed on a first surface of the motherboard opposite the voltage regulator assembly.

In some aspects, the techniques described herein relate to a computer system including: one or more integrated circuits; and a voltage regulator assembly including a power stage chip and an inductive component coupled to the power stage chip, wherein a footprint of the power stage chip is bonded to a surface of a printed circuit board, wherein the inductive component includes at least one coil, and wherein a first portion of the coil is disposed on or over a surface of the power stage chip, wherein the printed circuit board, the power stage chip, and the first portion of the coil are arranged in a stack, wherein the voltage regulator assembly is configured to provide a power supply signal to at least one integrated circuit of the one or more integrated circuits via the inductive component.

In some aspects, the techniques described herein relate to a computer system, wherein a structure of the inductive component is asymmetric.

In some aspects, the techniques described herein relate to a computer system, wherein a second portion of the coil is bonded to the first surface of the printed circuit board and situated laterally on the printed circuit board with respect to the power stage chip.

In some aspects, the techniques described herein relate to a computer system, wherein the power stage chip is a first power stage chip, wherein the voltage regulator assembly further includes a second power stage chip, and wherein a footprint of the second power stage chip is bonded to a second surface of the printed circuit board opposite the first surface.

In some aspects, the techniques described herein relate to a computer system, wherein the footprint of the second power stage chip is configured as a mirror reflection of the footprint of the first power stage chip.

In some aspects, the techniques described herein relate to a computer system, wherein the first portion of the coil is configured to provide a thermal path for at least some heat dissipated by the first and second power stage chips.

In some aspects, the techniques described herein relate to a computer system, wherein the voltage regulator assembly further includes a thermal pad disposed on or over the first power stage chip and a heat sink disposed on or over the thermal pad.

In some aspects, the techniques described herein relate to a computer system, wherein the power supply signal is a first power supply signal, and wherein the power stage chip is configured to control an amount of power transferred from a second power supply signal to the first power supply signal by the voltage regulator assembly.

In some aspects, the techniques described herein relate to a voltage regulator assembly including: a power stage chip; and an inductive component coupled to the power stage chip, wherein a footprint of the power stage chip is bonded to a surface of a printed circuit board, wherein the inductive component includes at least one coil, and wherein a first portion of the coil is disposed on or over a surface of the power stage chip, wherein the printed circuit board, the power stage chip, and the first portion of the coil are arranged in a stack, and wherein the voltage regulator assembly is configured to provide one or more power supply signals via the inductive component.

In some aspects, the techniques described herein relate to a voltage regulator assembly, wherein a structure of the inductive component is asymmetric.

In some aspects, the techniques described herein relate to a voltage regulator assembly, wherein a second portion of the coil is bonded to the first surface of the printed circuit board and situated laterally on the printed circuit board with respect to the power stage chip.

In some aspects, the techniques described herein relate to a voltage regulator assembly, wherein the power stage chip is a first power stage chip, wherein the voltage regulator assembly further includes a second power stage chip, and wherein a footprint of the second power stage chip is bonded to a second surface of the printed circuit board opposite the first surface.

In some aspects, the techniques described herein relate to a voltage regulator assembly, wherein the footprint of the second power stage chip is configured as a mirror reflection of the footprint of the first power stage chip.

In some aspects, the techniques described herein relate to a voltage regulator assembly, wherein the first portion of the coil is configured to provide a thermal path for at least some heat dissipated by the first and second power stage chips.

In some aspects, the techniques described herein relate to a voltage regulator assembly, wherein the voltage regulator assembly further includes a thermal pad disposed on or over the first power stage chip and a heat sink disposed on or over the thermal pad.

In some aspects, the techniques described herein relate to a method of assembling a voltage regulator assembly, the method including: bonding a footprint of a power stage chip to a surface of a printed circuit board; situating an inductive component on or over the surface of the printed circuit board, wherein a first portion of a coil of the inductive component is disposed on or over a surface of the power stage chip; and coupling a switch node of the power stage chip to the inductive component, wherein the printed circuit board, the power stage chip, and the first portion of the coil are arranged in a stack, and wherein the voltage regulator assembly is configured to provide one or more power supply signals via the inductive component.

In some aspects, the techniques described herein relate to a method, wherein the power stage chip is a first power stage chip, the method further including bonding a footprint of a second power stage chip to a second surface of the printed circuit board opposite the first surface, wherein the first power stage chip, the second power stage chip, and a printed circuit board are arranged in a stack.

In some aspects, the techniques described herein relate to a method, further including: coupling one or more first contacts of the footprint of the first power stage chip to one or more respective second contacts of the footprint of the second power stage chip through one or more respective through via of the printed circuit board.

In some aspects, the techniques described herein relate to a method, further including: prior to the bonding of the footprint of the second power stage chip to the second surface of the printed circuit board, orienting the second power stage chip such that the footprint of the second power stage chip is configured as a mirror reflection of the footprint of the first power stage chip.

In some aspects, the techniques described herein relate to a method, wherein the switch node of the second power stage chip is coupled to the inductive component through a through via of the printed circuit board and through a contact of the first power stage chip.

### Detailed Description of Some Examples of Vertical Voltage Regulator Assemblies

FIG. 4 illustrates one exemplary implementation of a computer system 400 configured to implement the techniques described herein, although others are possible. It should be appreciated that FIG. 4 is intended neither to be a depiction of necessary components for a computer system 400 to operate in accordance with the principles described herein, nor a comprehensive depiction.

Computer system 400 can be, for example, a desktop computer, a video game console, a server, a wireless access point or other networking element, a mobile computing device (e.g., laptop computers, tablets, smartphones, smartwatches, implantable health monitoring devices, wearable computers, personal digital assistants, etc.), or any other suitable computing system. Computer system 400 can comprise at least one central processing unit (CPU) 402, one or more integrated circuits 403 (e.g., graphics processing unit (GPU), accelerated processing unit (APU), vision processing unit (VPU), tensor processing unit (TPU), physics processing unit (PPU), digital signal processing (DSP) circuit, field programmable gate array (FPGA), application-specific integrated circuit (ASIC), other processing device, other integrated circuit etc.), connection circuitry 408, I/O circuitry 410, system memory 426, at least one I/O device 430, at least one accelerator 434, storage 446 (e.g., computer-readable storage media), and/or at least one display 428. In some examples, the CPU 402, integrated circuit(s) 403, connection circuitry 408, and I/O circuitry 410, are coupled to (e.g., mounted on) a printed circuit board (e.g., motherboard) 401.

CPU 402 enables processing of data and execution of instructions. The data and instructions can be stored on system memory 426, storage 446, and/or internal memory (not shown) of the CPU 402. In some examples, the CPU 402 includes one or more processor chiplets 404-1 . . . 404-N, which may be disposed on or over a package substrate 444. In some examples, the processor chiplets can communicate with each other via interconnects routed through or on the package substrate 444 (e.g., through an interposer layer disposed between the package substrate 444 and the processor chiplets). In some examples, each processor chiplet includes one or more cores (406, 408). Different processor chiplets can have the same or different numbers of cores (406, 408). In the example of FIG. 4, processor chiplet 404-1 has K cores 406-1 . . . 406-K, and processor chiplet 404-N has L cores (408-1, 408-2, . . . 408-L). The cores within an individual processor chiplet (e.g., cores 406-1 . . . 406-K) can be homogeneous or heterogeneous. Likewise, the cores on different processor chiplets (e.g., cores 406-1 and 408-1) can be homogeneous or heterogeneous.

In the example of FIG. 4, the CPU 402 is configured to execute instructions of an operating system 442 and/or instructions (e.g., program code 440) of one or more applications. In some examples, the functionality of the program code may be implemented by one or more integrated circuits 403, one or more CPUs 402, one or more processor chiplets of a CPU 402, and/or one or more cores of a processor chiplet.

The data and instructions stored on any of the computer-readable storage media (e.g., system memory 426, storage 446, accelerator memory 438, internal or external caches of the CPU 402, etc.) can include computer-executable instructions implementing any suitable functionality.

In some examples, connection circuitry 408 communicatively couples CPUs 402 with each other, with integrated circuit(s) 403, and/or with external caches (e.g., level-2 (L2) cache, level-3 (L3) cache, etc.). Additionally or alternatively, the connection circuitry 408 can communicatively couple the CPUs 402 with I/O circuitry 410, which communicatively couples system memory, storage devices, and peripheral devices to each other and (via the connection circuitry 408) to the CPUs 402. The connection circuitry can couple the CPUs 402, external caches, and I/O circuitry 410 using any suitable network topology (e.g., a front-side bus, a back-side bus, etc.), and the coupled components can send and receive messages via the connection circuitry using any suitable communication protocol. In some examples, portions of the connection circuitry 408 can be integrated into the CPU(s) 402 and/or integrated circuit(s) 403.

In some examples, I/O circuitry 410 includes one or more memory controllers 412, one or more storage connectors 420, display circuitry 418, one or more peripheral connectors 424, and a peripheral switch 422. The memory controller(s) 412 can be configured to control the flow of data to and from the system memory 426. The storage connector(s) 420 can be configured to control the flow of data to and from the storage 446. The display circuitry 418 can be configured to send visual data (e.g., user interface data, image data, video data, etc.) to the display 428, which can be configured to display the visual data. In some examples, the display circuitry 418 can also be configured to receive data representing user input from the display 428 (e.g., in cases where the display 428 includes a touchscreen). In some examples, portions of the I/O circuitry 410 can be integrated into a motherboard and/or motherboard chipset (e.g., I/O circuitry 410) of the computer system 400.

Each of the peripheral connectors 424 may be configured to physically connect and communicatively couple the I/O circuitry 410 to a peripheral device. Any suitable type of peripheral device can be connected to a peripheral connector 424 including, without limitation, an I/O device 430 (e.g., an input device, output device, or input/output device), an accelerator 434, etc. Some non-limiting examples of an input device can include a mouse, keyboard, scanner, video game controller, microphone, webcam, etc. Some non-limiting examples of an output device can include a display, printer, speakers, headphones, earbuds, etc. Some non-limiting examples of an input/output device can include a storage device (e.g., disk drive, solid-state drive, universal serial bus (USB) flash drive, memory card, tape drive, etc.), a networking device (e.g., modem, router, gateway, network adapter, access point, etc.), etc. A networking adapter can be any suitable hardware and/or software to enable the computer system 400 to communicate via wires and/or wirelessly with any other suitable computing system over any suitable computing network. The computing network can include wireless access points, switches, routers, gateways, and/or other networking equipment as well as any suitable wired and/or wireless communication medium or media for exchanging data between two or more computers, including the Internet. Optionally, an I/O device can include one or more registers 432. In some examples, the I/O circuitry 410 can control the operation of an I/O device 430 by writing suitable data to one or more of the I/O device's registers, and/or can monitor the status of an I/O device 430 by reading the contents of one or more of the I/O device's registers.

Some non-limiting examples of an accelerator 434 can include a graphics processing unit (GPU), accelerated processing unit (APU), vision processing unit (VPU), tensor processing unit (TPU), physics processing unit (PPU), digital signal processing (DSP) circuit, field programmable gate array (FPGA), application-specific integrated circuit (ASIC), etc. In some examples, an accelerator 434 includes one or more registers 436 and memory 438. In some examples, the I/O circuitry 410 can control the operation of an accelerator 434 by writing suitable data to one or more of the accelerator's registers, and/or can monitor the status of an accelerator 434 by reading the contents of one or more of the accelerator's registers.

The peripheral switch 422 can be configured to switch packets sent to or from the peripheral devices. Any suitable type of peripheral connector(s) 424 and peripheral switch 422 can be used including, without limitation, universal serial bus (e.g., USB-A, USB-B, USB-C, USB-3.0, etc.), Ethernet, DisplayPort, high-definition multimedia interface (HDMI), peripheral component interconnect (PCI), peripheral component interconnect eXtended (PCI-X), peripheral component interconnect express (PCIe), accelerated graphics port (AGP), etc.

As described above computer system 400 can have one or more components and peripherals, including input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computing device can receive input information through speech recognition or in other audible format.

In some examples, computer system 400 further includes a voltage regulator 460. In some examples, the voltage regulator 460 receives power supply signals 452 (e.g., unregulated or insufficiently regulated power supply signals) from a power supply 450, and provides supply signal(s) (e.g., supply signals 484a-c) with regulated voltage(s) to CPU(s) 402, integrated circuit(s) 403, I/O circuitry 410, any other suitable components of the computer system 400, or any subset thereof. In some examples, the power supply 450 is a direct current (DC) power supply, and the signals provided by the power supply 450 are DC power supply signals 452. Some non-limiting examples of power supplies 450 can include one or more batteries (e.g., rechargeable batteries), an alternating current (AC) to DC power adapter (e.g., a power adapter for a mobile computing device), etc. In some examples, the voltage regulator 460 includes a voltage regulator (VR) controller 470 and at least one vertical VR assembly 480. In some examples, the VR controller 470, the vertical VR assembly 480, both components, or neither component is physically attached to (e.g., mounted on) a motherboard of computer system 400.

In some examples, the VR controller 470 of the voltage regulator 460 is configured to control the operation of the vertical VR assembly 480. For example, the VR controller 470 can control the number of regulated supply signals provided by the vertical VR assembly 480 (up to a maximum number of regulated supply signals that the vertical VR assembly 480 is capable of providing), the amplitudes of the voltages and/or currents of the regulated supply signal(s) provided by the vertical VR assembly 480, etc. In some examples, the VR controller 470 controls the vertical VR assembly 480 by providing one or more control signals 472 to the vertical VR assembly 480. Such control signals 472 can include one or more power supply signals (e.g., with voltages determined by the VR controller 470), signals controlling the operation of transistors in the power stages of the vertical VR assembly 480 (e.g., pulse-width modulated (PWM) signals controlling the duty cycles of such transistors), etc. In some examples, the VR controller 470 controls the vertical VR assembly 480 based on feedback signals 482 from the vertical VR assembly 480 indicating values of one or more parameters of the vertical VR assembly 480. Some non-limiting examples of such parameters can include temperature(s) sensed by the vertical VR assembly 480, voltages and/or currents of signals within the vertical VR assembly 480 or produced by the vertical VR assembly 480 (e.g., the regulated supply signal(s)), etc.

In some examples, the vertical VR assembly 480 of the voltage regulator 460 is configured to provide one or more regulated power supply signals to one or more components of the computer system 400. In some examples, the vertical VR assembly 480 implements a VR power circuit 120 (optionally including or excluding the capacitive component 152). In some examples, the VR power circuit implemented by the vertical VR assembly is a dual-phase power circuit. The vertical VR assembly 480 can provide each regulated power supply signal with any suitable voltage (e.g., 1 μV to 120 V) and/or any suitable current (e.g., 1 μA-500 A). In some examples, the vertical VR assembly 480 is electrically coupled to one or more components of the computer system 400 via the printed circuit board 401 (e.g., motherboard), and the regulated power supply signals are provided to the components of the computer system via traces, wires, or other conductive couplings of the printed circuit board. In some examples, the vertical VR assembly 480 includes one or more sensors (e.g., voltage sensors, current sensors, temperature sensors, etc.) operable to sense values of one or more parameters of the vertical VR assembly 480 and communicate those sensed values to the VR controller 470 via the feedback signals 482.

In some examples, the vertical VR assembly 480 includes vertically-integrated Pstage chips with mirrored footprints. FIG. 5A shows a top view of an example footprint 500 of a power stage chip (e.g., a first Pstage chip 610 or 660 of a vertical VR assembly 600 or 650 as shown in FIGS. 6A-6B). In some examples, the Pstage chip's footprint 500 includes a contact 502 coupled to the switch node (e.g., switch node 235) of the chip's power stage, contacts 504a and 504b configured to couple to the supply rail of the power supply, and contacts 506a and 506b configured to couple to the power supply's ground node. In some examples, the footprint 500 further includes contacts labeled TMON/FLT (e.g., configured to receive a temperature monitoring signal and/or a fault signal), IMON (e.g., configured to receive a current monitoring signal indicating an amplitude of a current within or provided by the Pstage chip), VCC (e.g., configured to be coupled to a power rail for switch control and driver circuitry of the Pstage chip), EN (e.g., configured to receive an enable signal), AGND (e.g., configured to be coupled to a ground return for the VCC supply signal), BOOT (e.g., configured to be coupled to a bootstrap capacitor), PWM (e.g., configured to receive a pulse width modulation control signal) and PHASE (e.g., configured to connect to the internal switch node). The footprint dimensions indicated in FIG. 5A are provided by way of example and are not limiting. In some examples, the footprint 500 is 3.5 mm by 4.5 mm. The surface of a chip opposite the chip's footprint is sometimes referred to herein as the “top” or “head surface” of the chip.

FIG. 5B shows a top view of an example footprint 510 of a power stage chip (e.g., second Pstage chip 612 or 662 of a vertical VR assembly 600 or 650 as shown in FIGS. 6A-6B). As described below in detail, Pstage chips 610 and 612 can have a mirrored footprint relationship with each other, and Pstage chips 660 and 662 can have a mirrored footprint relationship. In some examples, the Pstage chip's footprint 510 includes a contact 512 coupled to the switch node (e.g., switch node 235) of the chip's power stage, contacts 514a and 514b configured to couple to the supply rail of the power supply, and contacts 516a and 516b configured to couple to the power supply's ground node. In some examples, the footprint 510 further includes contacts labeled TMON/FLT (e.g., configured to receive a temperature monitor signal or to float), IMON (e.g., configured to receive current monitoring signal indicate an amplitude of a current within or provided by the Pstage chip), VCC (e.g., configured to be coupled to a power rail for switch control and driver circuitry of the Pstage chip), EN (e.g., configured to receive an enable signal), AGND, BOOT, and PHASE. The footprint dimensions indicated in FIG. 5B are provided by way of example and are not limiting. In some examples, the footprint 510 is 3.5 mm by 4.5 mm.

In the example of FIGS. 5A and 5B, each contact of the footprint 510 of the second Pstage chip is arranged in a mirror configuration relative to the corresponding contact of the footprint 500 of the first Pstage chip. In some examples, a subset of the contacts of the footprint 510 of the second Pstage chip are arranged in a mirror configuration relative to the corresponding contacts of the footprint 500 of the first Pstage chip, and other contacts are not arranged in a mirror configuration. For example, the contacts 512, 514a/514b, and 516a/516b of the footprint 510 can be arranged in a mirror configuration with respect to the contacts 502, 504a/504b and 506a/506b of the footprint 500. When a first Pstage chip and a second Pstage chip are disposed on opposite sides of a PCB with their footprints (500, 510) facing each other, contacts arranged in a mirror configuration can be vertically aligned and can face each other, such that the vertically aligned contacts can be coupled to each other by a via through the PCB.

FIG. 6A shows a side view of an example vertical VR assembly 600 with stacked power stage chips (610, 612). In some examples, the vertical VR assembly 600 implements a VR power circuit (optionally including or excluding the power circuit's capacitive component) in a single-phase configuration. In some examples, the vertical VR assembly 600 includes a first power stage chip 610, a second power stage chip 612, and at least a portion of a PCB 614 (e.g., a motherboard or any other suitable circuit board). Each of the power stage chips can be a packaged integrated circuit implementing a power stage of a voltage regulator (e.g., a Pstage 230). The first power stage chip 610 can be attached to a first surface of the PCB 614, and the second power stage chip 612 can be attached to a second surface of the PCB 614 opposite the first surface. Any suitable materials and/or techniques can be used to attach the power stage chips to the PCB.

The power stage chips (610, 612) can be situated such that their footprints are vertically aligned and face each other, with the PCB 614 interposed between the footprints. In some examples, the aligned and opposing footprints of the power stage chips (610, 612) can be configured as mirror reflections of each other. In some examples, portions (e.g., subsets of the contacts) of the aligned and opposing footprints of the power stage chips can be configured as mirror reflections of each other. Some examples of mirrored footprints are described above with reference to FIGS. 5A-5B.

In some examples, one or more vertically aligned contacts of the footprints of the power stage chips are electrically and/or thermally coupled through one or more vias 620 (e.g., “through vias” 620a-620h) of the PCB 614. For example, vertically aligned contacts configured to receive power supply signals (e.g., power supply signals 452) can be coupled to each other through via 620b, which can be referred to as a “shared power via.” In some examples, vertically aligned contacts configured to connect to the power supply ground node can be coupled to each other through one or more of vias 620d-620g. In some examples, vertically aligned contacts coupled to the switch nodes (e.g., switch nodes 235) of the power stage chips (610, 612) can be coupled to each other through via 620h, and optionally through one or more of vias 620d-620g.

In some examples, the vertical VR assembly 600 further includes an inductive component 630 (e.g., an inductor). The inductive component 630 can be situated laterally on the PCB 614 relative to the first power stage chip 610. The inductive component 630 can include a core 632 and a coil 634. In some examples, the inductive component 630 is packaged, and a surface 636 of the coil 634 is exposed at the top of the package. Exposing the top surface 636 of the coil 634 can facilitate heat dissipation. In some examples, the switch nodes of the power stage chips (610, 612) are both coupled to a terminal of the inductive component 630 (e.g., through a trace 624 connected between the through via 620h and the terminal of the inductive component 630). When the switch nodes of the two power stage chips are coupled together and coupled to the same terminal of an inductive component (as in the example of FIG. 6A), the two power stages and the inductive component can operate together as a single phase circuit (e.g., a high-power phase circuit). In some examples, the second terminal of the inductive component 630 is coupled to one or more downstream components (e.g., capacitive component, load, etc.) through one or more conductive couplings, which can include a trace 644 connected to the second terminal of the inductive component.

In some examples, the vertical VR assembly 600 further includes a thermal pad 616 and/or a heat sink 618. The thermal pad can be stacked on or above the first power stage chip 610 (e.g., on a top surface of the first power stage chip 610). The heat sink 618 can be stacked on or above the thermal pad 616.

In some examples, the vertical VR assembly 600 further includes one or more resistive components (Rx) (e.g., resistors, FETs biased to function as resistors, etc.) and/or one or more capacitive components (Cx) (e.g., capacitors). In some examples, one or more of the resistive and/or capacitive components can be coupled to the second terminal of the inductive component (e.g., between the inductive component and ground, between the inductive component and the vertical VR assembly's load, etc.). The resistive and/or capacitive components can be attached to either surface of the PCB 614. In configurations in which the resistive and/or capacitive components are attached to the bottom surface of the PCB, they can be coupled to the inductive component 630 by one or more through vias of the PCB (not shown).

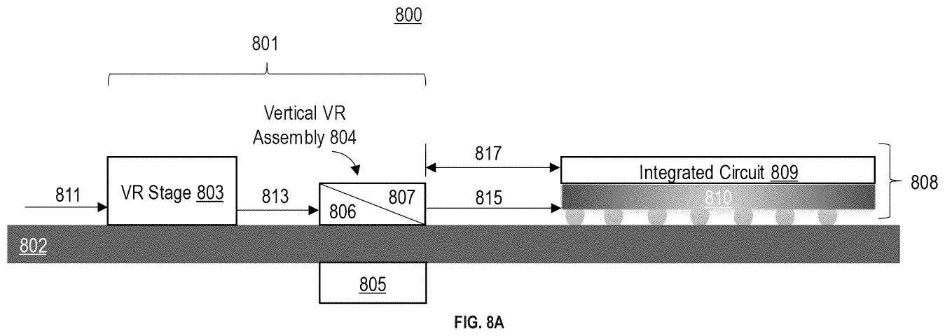

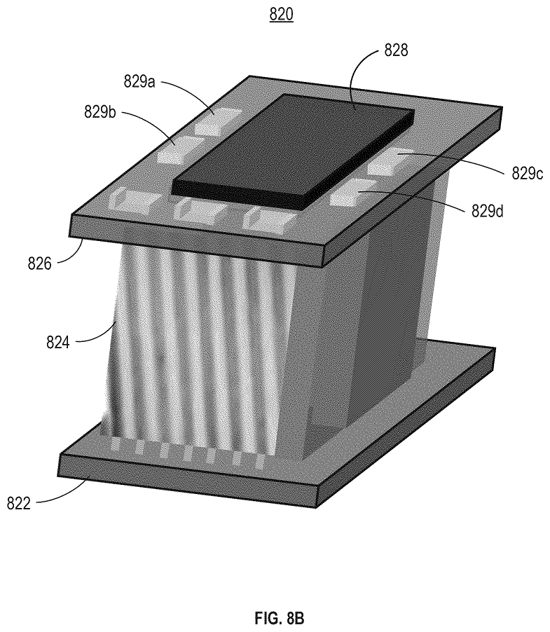

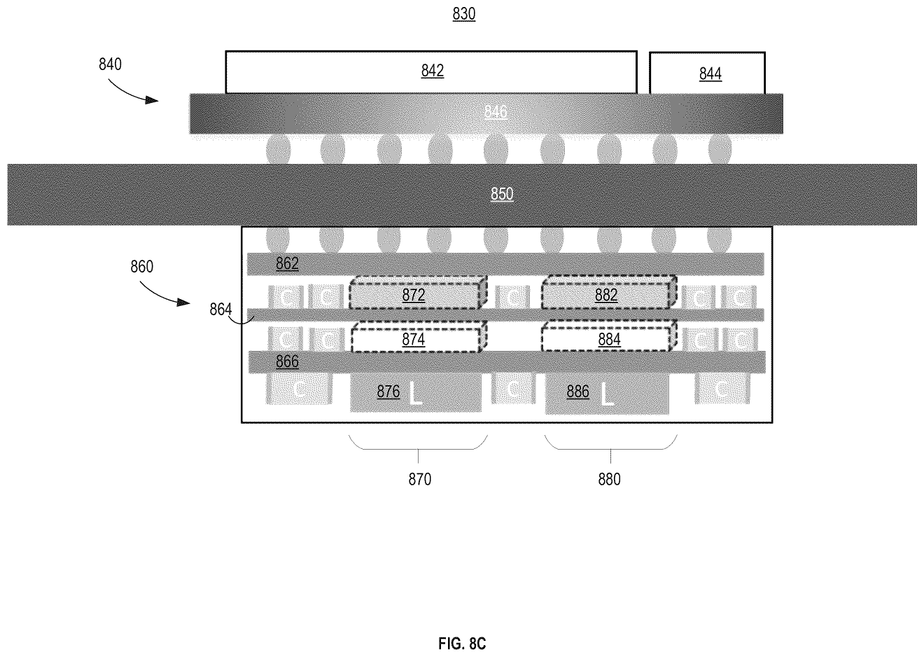

In some examples, the vertical VR assembly 600 can be situated on a surface of the motherboard of a computer system (e.g., PCB 614), and the VR's load (e.g., a processing device or other integrated circuit) can be laterally situated on the same surface of the motherboard with respect to the vertical VR assembly. In some examples, the lateral distance between the vertical VR assembly 600 (e.g., the second terminal of the inductive component of the vertical VR assembly) and its load along the surface of the motherboard can be relatively short (e.g., 25-50 mm, 35-45 mm, 40 mm, etc.). In some examples, the vertical VR assembly can be the final stage of a multi-stage VR, as illustrated in FIG. 8A. In some examples, the vertical VR assembly's load can be situated on a surface of the motherboard, and the vertical VR assembly can be attached to the opposing surface of the motherboard. In such configurations, the vertical VR assembly can be situated opposite to (e.g., under) its load and coupled to the load by one or more vias through the motherboard.

In the example of FIG. 6A, the inductive component 630 of the vertical VR assembly is situated laterally with respect to the first Pstage chip 610. In other examples, the inductive component can be vertically integrated with (e.g., stacked on) the Pstage chips, as illustrated in FIG. 7A.

FIG. 6B shows a side view of an example vertical VR assembly 650 with stacked power stage chips (660, 662). In some examples, the vertical VR assembly 650 implements a VR power circuit (optionally including or excluding the power circuit's capacitive component) in a dual-phase (e.g., two-phase or “phase doubler”) configuration. In some examples, the vertical VR assembly 650 includes a first power stage chip 660, a second power stage chip 662, and at least a portion of a PCB 664 (e.g., a motherboard or any other suitable circuit board). Each of the power stage chips can be a packaged integrated circuit implementing a power stage of a voltage regulator (e.g., a Pstage 230). The first power stage chip 660 can be attached to a first surface of the PCB 664, and the second power stage chip 662 can be attached to a second surface of the PCB 664 opposite the first surface. Any suitable materials and/or techniques can be used to attach the power stage chips to the PCB.

The power stage chips (660, 662) can be situated such that their footprints are vertically aligned and face each other, with the PCB 664 interposed between the footprints. In some examples, the aligned and opposing footprints of the power stage chips (660, 662) can be configured as mirror reflections of each other. In some examples, portions (e.g., subsets of the contacts) of the aligned and opposing footprints of the power stage chips can be configured as mirror reflections of each other. Some examples of mirrored footprints are described above with reference to FIGS. 5A-5B.

In some examples, the vertical VR assembly 650 further includes an inductive component 680. The inductive component 680 can be situated laterally on the PCB 614 relative to the first Pstage chip 660. In some examples, the inductive component 680 includes multiple inductors (e.g., two inductors, a 2-in-1 inductor, etc.). The inductive component 680 can include a core 682 and two or more coils (e.g., first coil 684 and second coil 688). In some examples, the inductive component 680 is packaged, and a surface 686 of the first coil 684 is exposed at the top of the package. Exposing the top surface 686 of the first coil 684 can facilitate heat dissipation. In some examples, surfaces of the first and second coils are separated from each other by an insulator 689 (e.g., an insulating material or an air gap). In the example of FIG. 6B, the coils 684 and 688 are arranged in an inside-outside winding configuration, with the first coil 684 on the outside and the second coil 688 on the inside. Alternatively, a side-by-side winding configuration can be used, such that the coils are adjacent to each other in the z-direction rather than the x-direction. When a side-by-side winding configuration is used, top surfaces of the first coil 684 and the second coil 688 can be exposed at the top of the inductive component's package.

In some examples, one or more vertically aligned contacts of the footprints of the power stage chips are electrically and/or thermally coupled through one or more vias 670 (e.g., “through vias” 670a-670d) of the PCB 664. For example, vertically aligned contacts configured to receive power supply signals (e.g., power supply signals 452) can be coupled to each other through via 670b, which can be referred to as a “shared power via.” In some examples, vertically aligned contacts configured to connect to the power supply ground node can be coupled to each other through one or more vias (e.g., via 670d).

In some example, one or more contacts of the first Pstage chip 660 coupled to the switch node (e.g., switch node 235) of the chip's Pstage can be coupled to a first terminal of the first coil 684 through a trace 674 of the PCB 664. In some examples, one or more contacts of the second Pstage chip 662 coupled to the switch node (e.g., switch node 235) of the chip's Pstage can be coupled to a first terminal of the second coil 688 through a via-trace 670e. When the switch nodes of the two power stage chips (660, 662) are connected to terminals of different inductors (e.g., different coils of a 2-in-1 inductor), as in the example of FIG. 6B, the two power stages and two inductors can operate as two distinct phase circuits in a dual-phase configuration (e.g., a two-phase or “phase doubler” configuration). In some examples, when a 2-in-1 inductor is used, the 2-in-1 inductor can balance the load currents between the dual phase circuits.

In some examples, the second terminal of the first coil 684 is coupled to one or more downstream components (e.g., loads) through one or more conductive couplings, which can include a trace 694 connected to the second terminal of the first coil 684. In some examples, the second terminal of the second coil 688 is coupled to one or more downstream components (e.g., loads) through one or more conductive couplings, which can include a via-trace 698 connected to the second terminal of the second coil 688.

In some examples, the vertical VR assembly 650 further includes a thermal pad 666 and/or a heat sink 668. The thermal pad can be stacked on or above the first power stage chip 660 (e.g., on a top surface of the first power stage chip 660). The heat sink 668 can be stacked on or above the thermal pad 666.

In some examples, the vertical VR assembly 650 further includes one or more resistive components (Rx) (e.g., resistors, FETs biased to function as resistors, etc.) and/or one or more capacitive components (Cx) (e.g., capacitors). In some examples, one or more of the resistive and/or capacitive components can be coupled to the second terminal of the first coil 684 (e.g., between the first coil and ground, between the first coil and a load, etc.). In some examples, one or more of the resistive and/or capacitive components can be coupled to the second terminal of the second coil 688 (e.g., between the second coil and ground, between the second coil and a load, etc.). The resistive and/or capacitive components can be attached to either surface of the PCB 614. In configurations in which the resistive and/or capacitive components are attached to the bottom surface of the PCB, they can be coupled to the coils of the inductive component 680 by trace 674, trace 694, trace-via 670e, trace-via 698, and/or one or more other through vias, buried vias, or traces of the PCB (not shown).

In some examples, the vertical VR assembly 600 can be situated on a surface of the motherboard of a computer system (e.g., PCB 614), and the VR's load (e.g., a processing device or other integrated circuit) can be laterally situated on the same surface of the motherboard with respect to the vertical VR assembly. In some examples, the lateral distance between the vertical VR assembly 600 (e.g., the second terminal of the inductive component of the vertical VR assembly) and its load along the surface of the motherboard can be relatively short (e.g., 25-50 mm, 35-45 mm, 40 mm, etc.). In some examples, the vertical VR assembly can be the final stage of a multi-stage VR, as illustrated in FIG. 8A. In some examples, the vertical VR assembly's load can be situated on a surface of the motherboard, and the vertical VR assembly can be attached to the opposing surface of the motherboard. In such configurations, the vertical VR assembly can be situated opposite to (e.g., under) its load and coupled to the load by one or more vias through the motherboard.

In the example of FIG. 6B, the inductive component 680 of the vertical VR assembly 650 is situated laterally with respect to the first Pstage chip 660. In other examples, the inductive component can be vertically integrated with (e.g., stacked on) the Pstage chips, as illustrated in FIG. 7B. In still other examples, a second inductive component can be attached to the bottom of the PCB 664 and situated laterally with respect to the second Pstage chip 662. In these examples, the switch node of the second Pstage chip 662 can be coupled to the second inductive component by a trace on the bottom surface of the PCB, and the second inductive component can be coupled to one or more downstream components (e.g., loads) through one or more conductive couplings, which can include a trace and/or a through via of the PCB.

FIG. 7A shows a side view of an example vertical VR assembly 700 with vertically-integrated (e.g., stacked) inductive component and power stage chips. In some examples, the vertical VR assembly 700 implements a VR power circuit (optionally including or excluding the power circuit's capacitive component) in a single-phase configuration. In some examples, the vertical VR assembly 700 includes a first power stage chip 710, a second power stage chip 712 (e.g., the second Pstage chip having a mirrored footprint of the first Pstage chip), at least a portion of a PCB 714 (e.g., a motherboard or any other suitable circuit board), and an inductive component 730. Each of the power stage chips can be a packaged integrated circuit implementing a power stage of a voltage regulator (e.g., a Pstage 230). The first Pstage chip 710 can be attached to a first surface of the PCB 714, and the second Pstage chip 712 can be attached to a second surface of the PCB 714 opposite the first surface. Any suitable materials and/or techniques can be used to attach the Pstage chips to the PCB. In some examples, the Pstage chips (710, 712) can share one or more decoupling capacitors.

The Pstage chips (710, 712) can be situated such that their footprints (e.g., footprints 500, 510) are vertically aligned and face each other, with the PCB 714 interposed between them. In some examples, the aligned and opposing footprints of the Pstage chips (710, 712) can be configured as mirror reflections of each other. In some examples, portions (e.g., subsets of the contacts) of the aligned and opposing footprints of the Pstage chips can be configured as mirror reflections of each other. Some examples of mirrored footprints are described above with reference to FIGS. 5A-5B.

In some examples, one or more vertically aligned contacts of the footprints of the Pstage chips are electrically and/or thermally coupled through one or more vias 720 (e.g., “through vias” 720a-720h) of the PCB 714. For example, vertically aligned contacts configured to receive power supply signals (e.g., power supply signals 452) can be coupled to each other through via 720g, which can be referred to as a “shared power via.” In some examples, vertically aligned contacts configured to connect to the power supply ground node can be coupled to each other through one or more of vias 720e-720f. In some examples, vertically aligned contacts coupled to the switch nodes (e.g., switch nodes 235) of the Pstage chips (710, 712) can be coupled to each other through one or more of vias 720a-720d.

In some examples, the vertical VR assembly 700 further includes a thermal pad 716a and/or a heat sink 718. The thermal pad 716a can be stacked on or above the inductive component 730 (e.g., on a top surface of the inductive component 730). The heat sink 718 can be stacked on or above the thermal pad 716a.

The inductive component 730 can include an inductor, which can include a core 732 and a coil 734. In some examples, at least a portion of the inductive component 730 (e.g., a portion of the coil 734 including a first terminal) is stacked vertically on or above the Pstage chips (710, 712). In some examples, another portion of the inductive component 730 (e.g., a portion the coil 734 including a second terminal) is situated laterally on the PCB 714 relative to the first Pstage chip 710.

In some examples, the inductive component 730 is configured to provide a thermal path 749 for transfer of heat generated by the first and second Pstage chips (710, 712) to the thermal pad 716a and the heat sink 718. In general, heat generated by the second Pstage chip 712 tends to rise through the PCB 714 to the first Pstage chip 710, and heat generated by the first and second Pstage chips tends to rise through the inductive component 730 to the thermal pad 716a and the heat sink 718. In some examples, the through vias 720 coupling the contacts on the footprints of the first and second Pstage chips provide an efficient thermal path for transfer of heat from the first Pstage chip to the second Pstage chip. In some examples, the head surface of the first Pstage chip includes an exposed contact 724 (e.g., top exposed contact), which is internally coupled to the switch node of the first Pstage chip and externally coupled to the switch node of the second Pstage chip through vias (e.g., vias 720a-720d). In some examples, portions of the exposed contact 724 are aligned above the contact 512 of the footprint 510 of the second Pstage chip, the through vias 720a-720d, and the contact 502 of the footprint 500 of the first Pstage chip. In some examples, the first Pstage chip includes one or more vertical vias coupling the contact 502 of the chip's footprint 500 to the exposed contact 724 on the chip's head surface. The above-mentioned contacts and vias can provide an efficient thermal path for transfer of heat from the first and second Pstage chips to the exposed contact 724. Thus, in some examples, a thermal path 749 through the vertical VR assembly 700 is illustrated by the arrow outlined in dashed line in FIG. 7A.

In some examples, the vertical VR assembly 700 further includes a thermal pad 716b disposed on the head surface of the first Pstage chip 710 and situated laterally with respect to the exposed contact 724. In some examples, the thermal pad 716b tends to redirect rising heat away from core 732 and toward coil 734, thereby increasing the efficiency of the thermal path for heat generated by the Pstage chips. In some examples, the inductive component 730 is packaged, and a surface 736 of the coil 734 is exposed at the top of the package. Exposing the top surface 736 of the coil 734 can facilitate heat transfer from the coil 734 to the thermal pad 716a and the heat sink 718.

In some examples, the vertical VR assembly 700 provides a compact power delivery path (e.g., current path 747), which facilitates efficient transfer of power from the vertical VR assembly's input (e.g., contacts 504a/504b and 514a/514b of the footprints of the Pstage chips) to the vertical VR assembly's output (e.g., the second terminal of the coil 734). In some examples, the power supply input to the vertical VR assembly 700 is coupled to the switch nodes of the first and second Pstage chips through contacts 504a/504b and 514a/514b on the chips'footprints and through the chips'respective power stages. In some examples, the switch nodes of the power stage chips (710, 712) are both coupled to a first terminal of the inductive component 730 (e.g., through exposed contact 724 on the head surface of the first Pstage chip 710). When the switch nodes of the two Pstage chips are coupled together and coupled to the same terminal of an inductive component (as in the example of FIG. 7A), the two power stages and the inductive component can operate together as a single phase circuit (e.g., a high-power phase circuit). In some examples, the second terminal of the coil 734 is coupled to one or more downstream components (e.g., loads) through one or more conductive couplings, which can include a trace 744 connected to the second terminal of the coil 734. Thus, in some examples, a current path 747 through the vertical VR assembly 700 is illustrated by the arrows outlined in solid line in FIG. 7A.

In some examples, the structure of the inductive component 730 is asymmetric. In some examples, the asymmetry in the structure of the inductive component (e.g., in the shape of the coil 734 of the inductive component 730) helps to make the vertical VR assembly 700 compact, and helps to improve the efficiency of the thermal path and power delivery path through the vertical VR assembly. For example, the coil can be generally U-shaped, with a first side of the U-shape having a length 731a and the second side of the U-shape having a length 731b greater than the length 731a of the first side. The difference between the lengths of the coil's sides can be roughly equal to the thickness of the first Pstage chip 710. Thus, the first side of the coil can be disposed directly on (or proximate to) the exposed contact 724 on the head surface of the first Pstage chip, and the second side of the coil can be disposed directly on (or proximate to) the surface of the PCB 714, thereby avoiding the use of additional interconnects that could compromise the efficiency of the thermal path and/or the power delivery path.

In some examples, the vertical VR assembly 700 can be situated on a surface of the motherboard of a computer system (e.g., PCB 714), and the VR's load (e.g., a processing device or other integrated circuit) can be laterally situated on the same surface of the motherboard with respect to the vertical VR assembly. In some examples, the lateral distance between the vertical VR assembly 700 (e.g., the second terminal of the inductive component of the vertical VR assembly) and its load along the surface of the motherboard can be relatively short (e.g., 25-50 mm, 35-45 mm, 40 mm, etc.). In some examples, the vertical VR assembly can be the final stage of a multi-stage VR, as illustrated in FIG. 8A. In some examples, the vertical VR assembly's load can be situated on a surface of the motherboard, and the vertical VR assembly can be attached to the opposing surface of the motherboard. In such configurations, the vertical VR assembly can be situated opposite to (e.g., under) its load and coupled to the load by one or more vias through the motherboard.

In the example of FIG. 7A, the inductive component 730 is vertically integrated with a pair of stacked power stage chips. In some examples, the inductive component 730 is vertically integrated with a single power stage chip (e.g. first power stage chip 710).

FIG. 7B shows a side view of an example vertical VR assembly 750 with vertically-integrated (e.g., stacked) inductive component and power stage chips. In some examples, the vertical VR assembly 750 implements a VR power circuit (optionally including or excluding the power circuit's capacitive component) arranged in a dual-phase (e.g., two-phase or “phase doubler”) configuration. In some examples, the vertical VR assembly 750 includes a first power stage chip 760, a second power stage chip 762, at least a portion of a PCB 764 (e.g., a motherboard or any other suitable circuit board), and an inductive component 780. Each of the Pstage chips can be a packaged integrated circuit implementing a power stage of a voltage regulator (e.g., a Pstage 230). The first Pstage chip 760 can be attached to a first surface of the PCB 764, and the second Pstage chip 762 can be attached to a second surface of the PCB 764 opposite the first surface. Any suitable materials and/or techniques can be used to attach the Pstage chips to the PCB. In some examples, the Pstage chips (760, 762) can share one or more decoupling capacitors.

The Pstage chips (760, 762) can be situated such that their footprints (e.g., footprints 500, 510) are vertically aligned and face each other, with the PCB 764 interposed between them. In some examples, the aligned and opposing footprints of the Pstage chips (760, 762) can be configured as mirror reflections of each other. In some examples, portions (e.g., subsets of the contacts) of the aligned and opposing footprints of the Pstage chips can be configured as mirror reflections of each other. Some examples of mirrored footprints are described above with reference to FIGS. 5A-5B.

In some examples, one or more vertically aligned contacts of the footprints of the Pstage chips are electrically and/or thermally coupled through one or more vias 770 (e.g., “through vias” 770a-770h) of the PCB 764. For example, vertically aligned contacts configured to receive power supply signals (e.g., power supply signals 452) can be coupled to each other through via 770g, which can be referred to as a “shared power via.” In some examples, vertically aligned contacts configured to connect to the power supply ground node can be coupled to each other through one or more of vias 770e-770f. In some examples, vertically aligned contacts coupled to the switch nodes (e.g., switch nodes 235) of the Pstage chips (760, 762) can be coupled to each other through one or more of vias 770a-770d.

In some examples, the vertical VR assembly 750 further includes a thermal pad 766a and/or a heat sink 768. The thermal pad 766a can be stacked on or above the inductive component 780 (e.g., on a top surface of the inductive component 780). The heat sink 768 can be stacked on or above the thermal pad 766a.

The inductive component 780 can include multiple inductors (e.g., two inductors, a 2-in-1 inductor, etc.). In some examples, the inductive component 780 includes a core 782 and two or more coils (e.g., first coil 784 and second coil 788). In some examples, at least a portion of the inductive component 780 (e.g., portions of the first and second coils including first terminals of the coils) is stacked vertically on or above the Pstage chips (760, 762). In some examples, another portion of the inductive component 780 is situated laterally on the PCB 764 relative to the first Pstage chip 760.

Before describing the thermal path and power delivery path through the vertical VR assembly 750, some possible distinctions between the first Pstage chip 760 of FIG. 7B and the first Pstage chip 710 of FIG. 7A are noted. In some examples, the first Pstage chip 760 has two exposed contacts 774 and 778 on the head surface of the Pstage chip. In some examples, the exposed contact 774 is internally coupled to the contact 502 of the footprint 500 of the Pstage chip 760 (e.g., by one or more vias and/or traces within the Pstage chip 760) but is not internally coupled to the switch node (e.g., switch node 235) of the Pstage chip's power stage. In some examples, the exposed contact 778 is internally coupled to the switch node of the power stage of the Pstage chip 760 but is not internally coupled to the contact 502 of the footprint 500 of the Pstage chip 760. Thus, in some examples, the first Pstage chip 760 provides signals received at contact 502 to exposed contact 774, and provides signals provided at the power stage's switch node to the exposed contact 778.

In some examples, the inductive component 780 is configured to provide a thermal path 799 for transfer of heat generated by the first and second Pstage chips (760, 762) to the thermal pad 766a and the heat sink 768. In general, heat generated by the second Pstage chip 762 tends to rise through the PCB 764 to the first Pstage chip 760, and heat generated by the first and second Pstage chips tends to rise through the inductive component 780 to the thermal pad 766a and the heat sink 768. In some examples, the through vias 770 coupling the contacts on the footprints of the first and second Pstage chips provide an efficient thermal path for transfer of heat from the first Pstage chip to the second Pstage chip. In some examples, portions of the exposed contacts 774 and 778 are aligned above the contact 512 of the footprint 510 of the second Pstage chip, the through vias 770a-770d, and the contact 502 of the footprint 500 of the first Pstage chip. Thus, the components of the vertical VR assembly 750 can provide an efficient thermal path for transfer of heat from the first and second Pstage chips to the exposed contacts 774 and 778.

In some examples, the vertical VR assembly 750 further includes a thermal pad 766b disposed on the head surface of the first Pstage chip 760 and situated laterally with respect to the exposed contacts 774 and 778. In some examples, the thermal pad 766b tends to redirect rising heat away from core 782 and toward coils 784 and 788, thereby increasing the efficiency of the thermal path for heat generated by the Pstage chips.

In some examples, the inductive component 780 is packaged, and a surface 786 of the first coil 784 is exposed at the top of the package. Exposing the top surface 786 of the first coil 784 can facilitate heat dissipation. In some examples, surfaces of the first and second coils are separated from each other by an insulator 789 (e.g., an insulating material or an air gap). In the example of FIG. 7B, the coils 784 and 788 are arranged in an inside-outside winding configuration, with the first coil 784 on the outside and the second coil 788 on the inside. Alternatively, a side-by-side winding configuration can be used, such that the coils are adjacent to each other in the z-direction rather than the x-direction. When a side-by-side winding configuration is used, top surfaces of the first coil 784 and the second coil 788 can be exposed at the top of the inductive component's package. Thus, in some examples, a thermal path 799 through the vertical VR assembly 750 is illustrated by the arrow outlined in dashed line in FIG. 7B.

In some examples, the vertical VR assembly 750 provides compact power delivery paths (e.g., first current path 797a and second current path 797b), which facilitate efficient transfer of power from the vertical VR assembly's input to its output. In some examples, the power supply input to the vertical VR assembly 750 is coupled to the switch nodes of the first and second Pstage chips through contacts 504a/504b and 514a/514b on the chips'footprints and through the chips'respective power stages. In some examples, the switch node of the first Pstage chip 760 is coupled to the first terminal of the second coil 788 of the inductive component 780 (e.g., through exposed contact 778 on the head surface of the first Pstage chip 760), and the switch node of the second power stage chip 762 is coupled to the first terminal of the first coil 784 of the inductive component 780 (e.g., through switch contact 512 on the footprint of the second Pstage chip 762, one or more vias (e.g., vias 770a-d), switch contact 502 on the footprint of the first Pstage chip 760, and exposed contact 774 on the head surface of the first Pstage chip 760). When the switch nodes of the two power stage chips (760, 762) are connected to terminals of different inductors (e.g., different coils of a 2-in-1 inductor), as in the example of FIG. 7B, the two power stages and two inductors can operate as two distinct phase circuits in a dual-phase configuration (e.g., a two-phase or “phase doubler” configuration). In some examples, when a 2-in-1 inductor is used, the 2-in-1 inductor can balance the load currents between the two phase circuits.

In some examples, the first coil 784 is coupled to one or more downstream components (e.g., loads) through one or more conductive couplings, which can include a trace 794 connected to the second terminal of the first coil 784. In some examples, the second coil 788 is coupled to one or more downstream components (e.g., loads) through one or more conductive couplings, which can include a via-trace 798 connected to the second terminal of the second coil 788. Thus, in some examples, a first current path 797a of current produced by the second Pstage chip 762 through the vertical VR assembly 750 is illustrated by the dashed-line arrows shown in FIG. 7B, and a second current path 797b of current produced by the first Pstage chip 760 through the vertical VR assembly 750 is illustrated by the solid-line arrows shown in FIG. 7B.

In some examples, structure of the inductive component 780 is asymmetric. In some examples, the asymmetry in the structure of the inductive component (e.g., in the shapes of the coils 784 and 788 of the inductive component 780) helps to make the vertical VR assembly 750 compact, and helps to improve the efficiency of the thermal path and power delivery path through the vertical VR assembly 750, for reasons described above with reference to the inductive component 730 of vertical VR assembly 700.

In some examples, the vertical VR assembly 750 can be situated on a surface of the motherboard of a computer system (e.g., PCB 764), and the VR's load (e.g., a processing device or other integrated circuit) can be laterally situated on the same surface of the motherboard with respect to the vertical VR assembly. In some examples, the lateral distance between the vertical VR assembly 750 (e.g., the second terminals of the coils of the inductive component of the vertical VR assembly 750) and its loads along the surface of the motherboard can be relatively short (e.g., 25-50 mm, 35-45 mm, 40 mm, etc.). In some examples, the vertical VR assembly 750 can be the final stage of a multi-stage VR, as illustrated in FIG. 8A. In some examples, the vertical VR assembly's load can be situated on a surface of the motherboard, and the vertical VR assembly 750 can be attached to the opposing surface of the motherboard. In such configurations, the vertical VR assembly can be situated opposite to (e.g., under) its load and coupled to the load by one or more vias through the motherboard.

FIG. 8A shows an example system 800 including an example multi-stage voltage regulator 801. The system 800 can include a PCB 802 (e.g., motherboard), a multi-stage (or “cascading”) voltage regulator 801, and an integrated circuit (IC) package 808. In some examples, the multi-stage VR 801 includes a first voltage regulator stage 803 and a second voltage regulator stage, which can be the closest VR stage to the IC package 808. In some examples, the first VR stage 803 receives a power supply signal 811 with a relatively high voltage (e.g., 48 V) and provides a regulated power supply signal 813 with a lower voltage (e.g., 24 V) to the second VR stage.

In some examples, the second VR stage includes a vertical VR assembly 804 (e.g., vertical VR assembly 600, 650, 700, or 750). In some examples, the vertical VR assembly 804 includes a first power stage chip 806 (e.g., first Pstage chip 610, 660, 710, or 760) disposed on a first (e.g., top) surface of the PCB 802, a second power stage chip 805 (e.g., second Pstage chip 612, 662, 712, or 762) disposed on a second (e.g., bottom) surface of the PCB, and an inductive component 807 (e.g., inductive component 630, 680, 730, or 780). In some examples, the vertical VR assembly 804 produces a regulated power supply signal 815 with a relatively low voltage (e.g., 1-5 V) based on the power supply signal 813, and provides the regulated power supply signal to the IC package 808. In some examples, the distance 817 between the vertical VR assembly 804 and the IC package 808 is between 30 and 50 mm (e.g., 40 mm).

The IC package 808 can include an integrated circuit 809 (e.g., processor) and a PCB or substrate 810. The IC 809 can be any suitable IC capable of performing any suitable function.

FIG. 8B shows an example vertical VR device 820. In some examples, the vertical VR device 820 includes a first PCB 822 (e.g., a motherboard) or a portion thereof, an inductive component 824 disposed on the first PCB, a second PCB 826 disposed on the inductive component, and a vertical VR assembly 828 disposed on the second PCB. In some examples, the vertical VR assembly 828 (e.g., vertical VR assembly 600 or 650) includes first and second stacked Pstage chips.

In some examples, the vertical VR device 820 further includes decoupling capacitors (e.g., decoupling capacitors 829a-d). In contrast to the reduced-footprint VR device 300 of FIG. 3A, the vertical VR device 820 of FIG. 8B can have more and/or larger decoupling capacitors (because the footprint of the vertical VR assembly 828 on PCB 826 is smaller than the footprint of the power stage chips (340, 350) on the PCB 330 of the reduced-footprint VR device 300. Thus, the performance of the vertical VR device 820 can be superior to the performance of the reduced-footprint VR device 300. Also, the primary constraint on the width of the vertical VR device 820 is the width of the inductive component 824 rather than the widths of two power stage chips.

FIG. 8C shows an example system 830 including an example vertical VR device 860 disposed under an integrated circuit package 840. In some examples, the IC package 840 includes a PCB or substrate 846, a first integrated circuit 842 (e.g., processor) disposed on the PCB or substrate 846, and a second integrated circuit 844 situated laterally with respect to the first IC 842 on the PCB or substrate 846. The first IC can be any suitable IC (e.g., a CPU). The second IC can be any suitable IC (e.g., a GPU). In some examples, the IC package is an XPU. In some examples, the IC package 840 is disposed on a first (e.g., top) surface of a PCB 850 (e.g., a motherboard).

In some examples, the vertical VR device 860 is a packaged device including a first vertical VR assembly 870 and a second VR assembly 880. In some examples, the first vertical VR assembly 870 includes a first power stage chip 874 disposed on a first surface of a PCB 864 (with its footprint facing the first surface of the PCB) and a second power stage chip 872 disposed opposite the first power stage chip on a second surface of the PCB 864 (with its footprint facing the second surface of the PCB). In some examples, the first vertical VR assembly 870 further includes an inductive component 876, which can be laterally or vertically integrated with the first and second mirrored-footprint Pstage chips (874, 872). In some examples, a PCB 866 is interposed between the first Pstage chip 874 and the inductive component 876, rather than those components being in direct contact. In some examples, the first vertical VR assembly 870 further includes one or more decoupling capacitors C.

In some examples, the second vertical VR assembly 880 includes a first Pstage chip 884 disposed on the first surface of the PCB 864 (with its footprint facing the first surface of the PCB) and a second power stage chip 882 disposed opposite the first Pstage chip on the second surface of the PCB 864 (with its footprint facing the second surface of the PCB). In some examples, the second vertical VR assembly 880 further includes an inductive component 886, which can be laterally or vertically integrated with the first and second mirrored-footprint Pstage chips (884, 882). In some examples, the PCB 866 is interposed between the first Pstage chip 884 and the inductive component 886, rather than those components being in direct contact. In some examples, the first vertical VR assembly 880 further includes one or more decoupling capacitors C.

In some examples, a PCB 862 is bonded to the head surfaces of the second Pstage chips (872, 882) of the first and second vertical VR assemblies (870, 880) and attached to a second (e.g., bottom) surface of the PCB 850, opposite the IC package 840.

FIG. 9 illustrates an example method 900 for manufacturing (e.g., assembling) a vertical VR assembly. In some examples, the method 900 includes a step 910 of bonding a footprint of a first Pstage chip to a first surface of a printed circuit board. Any suitable materials and/or techniques can be used to bond the footprint of the first Pstage chip to the PCB, e.g., bump bonding the contacts of the footprint of the first Pstage chip to through vias at the first surface of the PCB.

In some examples, the method 900 further includes a step 920 of bonding a footprint of a second Pstage chip to a second surface of the PCB opposite the first surface. Any suitable materials and/or techniques can be used to bond the footprint of the second Pstage chip to the PCB, e.g., bump bonding the contacts of the footprint of the second Pstage chip to through vias at the second surface of the PCB. Prior to the bonding of the footprint of the second Pstage chip to the second surface of the PCB, the second Pstage chip can be oriented such its footprint is configured as a mirror reflection of the footprint of the first Pstage chip. After bonding the footprints of the first and second Pstage chips to the PCB, the through vias of the PCB can conductively couple the opposing contacts of the Pstage chips.

In some examples, the method 900 further includes a step 930 of situating an inductive component on or over the first surface of the PCB. In some examples, at least a portion of the inductive component is stacked on the head surface of the first Pstage chip. In some examples, the entire inductive component is situated laterally on the first surface of the PCB with respect to the first Pstage chip.

In some examples, the method 900 further includes a step 940 of coupling a switch node of the first Pstage chip and a switch node of the second Pstage chip to the inductive component. In some examples, the switch node of the first Pstage chip is coupled to the laterally-integrated inductive component through a trace on the PCB. In some examples, the switch node of the first Pstage chip is coupled to the vertically-integrated inductive component through a contact on a head surface of the first Pstage chip. In some examples, the switch node of the second Pstage chip is coupled to the inductive component through a through via of the PCB. In some examples, the switch node of the second Pstage chip is also coupled to the inductive component through a contact of the footprint of the first Pstage chip and an exposed contact of the head surface of the first Pstage chip.

In some examples, the inductive component includes at least one coil, and a first portion of the coil is situated on or over a head surface of the first Pstage chip. In some examples, a second portion of the coil is bonded to the first surface of the PCB. The inductive component can be configured to provide one or more power supply signals of the vertical VR assembly to one or more loads (e.g., integrated circuits).

Optionally, the method 900 further includes situating a thermal pad on or over the first Pstage chip. Optionally, the method further includes situating a heat sink on or over the thermal pad. Optionally, the method further includes coupling an input terminal of the vertical VR assembly to an output terminal of another voltage regulator power circuit disposed on the PCB.

In some examples, the first Pstage chip, the second Pstage chip, and the PCB are arranged in a stack. In some examples, that PCB is the motherboard of a computer system. Alternatively, the PCB stacked between the Pstage chips is not the motherboard. In the latter case, the method 900 can include an additional step of coupling the vertical VR assembly to a motherboard. In some examples, a load of the vertical VR assembly (e.g., an integrated circuit) is disposed on a first surface of the motherboard, and the vertical VR assembly is coupled to a second surface of the motherboard opposite the load.

Examples have been described in which spatial relationships between or among components are characterized as “vertical” or “lateral.” In general, as used herein, “vertical” can refer to the direction normal to the surfaces of the PCB on which the Pstages are mounted, and “lateral” can refer to the direction parallel to those surfaces of the PCB.

Examples have been described in which a vertical VR assembly includes two power stages disposed in distinct Pstage chips. In some examples, the power stages can be integrated in a single integrated circuit or package.

Techniques operating according to the principles described herein can be implemented in any suitable manner. While the foregoing disclosure sets forth various implementations using specific block diagrams, flowcharts, and examples, each block diagram component, flowchart step, operation, and/or component described and/or illustrated herein can be implemented, individually and/or collectively, using a wide range of hardware, software, or firmware (or any combination thereof) configurations. In addition, any disclosure of components contained within other components should be considered as non-limiting examples since many other architectures can be implemented to achieve the same functionality.

Included in the discussion above are flowcharts showing steps and acts of processes that regulate the voltage of a signal. The processing and decision blocks of the flowcharts above represent steps and acts that can be included in algorithms that carry out these processes. Algorithms derived from these processes (or steps thereof) can be implemented as software integrated with and directing the operation of one or more single-or multi-purpose processors (e.g., central processing units (CPUs), graphics processing units (GPUs), tensor processing units (TPUs), hardware accelerators, etc.), can be implemented as functionally-equivalent circuits such as a Digital Signal Processing (DSP) circuit, Field Programmable Gate Array (FPGA), or an Application-Specific Integrated Circuit (ASIC), or can be implemented in any other suitable manner. It should be appreciated that the flowchart(s) included herein do not depict the syntax or operation of any particular circuit or of any particular programming language or type of programming language. Rather, the flowchart(s) illustrate the functional information one of ordinary skill in the art can use to fabricate circuits or to implement computer software algorithms to perform the processing of a particular apparatus carrying out the types of techniques described herein. It should also be appreciated that, unless otherwise indicated herein, the particular sequence of steps and/or acts described in each flowchart is merely illustrative of the algorithms that can be implemented and can be varied in implementations and embodiments of the principles described herein.

Accordingly, in some embodiments, the techniques described herein can be embodied in computer-executable instructions implemented as software, including as application software, system software, firmware, middleware, embedded code, or any other suitable type of software. Such computer-executable instructions can be written using any of a number of suitable programming languages and/or programming or scripting tools, and also can be compiled as executable machine language code or intermediate code that is executed on a framework or virtual machine.

When techniques described herein are embodied as computer-executable instructions, these computer-executable instructions can be implemented in any suitable manner, including as a number of functional facilities, each providing one or more operations to complete execution of algorithms operating according to these techniques. A “functional facility,” however instantiated, is a structural component of a computer system that, when integrated with and executed by one or more computers, causes the one or more computers to perform a specific operational role. A functional facility can be a portion of or an entire software element. For example, a functional facility can be implemented as a function of a process, or as a discrete process, or as any other suitable unit of processing. If techniques described herein are implemented as multiple functional facilities, each functional facility can be implemented in its own way; all need not be implemented the same way. Additionally, these functional facilities can be executed in parallel and/or serially, as appropriate, and can pass information between one another using a shared memory on the computer(s) on which they are executing, using a message passing protocol, or in any other suitable way.

Generally, functional facilities include routines, programs, objects, components, data structures, etc. that perform particular tasks or implement particular abstract data types. Typically, the functionality of the functional facilities can be combined or distributed as desired in the systems in which they operate. In some implementations, one or more functional facilities carrying out techniques herein can together form a complete software package. These functional facilities can, in alternative embodiments, be adapted to interact with other, unrelated functional facilities and/or processes, to implement a software program application. In other implementations, the functional facilities can be adapted to interact with other functional facilities in such a way as form an operating system, including the Windows® operating system, available from the Microsoft® Corporation of Redmond, Washington. In other words, in some implementations, the functional facilities can be implemented alternatively as a portion of or outside of an operating system.

Some exemplary functional facilities have been described herein for carrying out one or more tasks. It should be appreciated, though, that the functional facilities and division of tasks described is merely illustrative of the type of functional facilities that can implement the exemplary techniques described herein, and that embodiments are not limited to being implemented in any specific number, division, or type of functional facilities. In some implementations, all functionality can be implemented in a single functional facility. It should also be appreciated that, in some implementations, some of the functional facilities described herein can be implemented together with or separately from others (i.e., as a single unit or separate units), or some of these functional facilities can be omitted.

Computer-executable instructions implementing the techniques described herein (when implemented as one or more functional facilities or in any other manner) can, in some embodiments, be encoded on one or more computer-readable media to provide functionality to the media. Computer-readable media include magnetic media such as a hard disk drive, optical media such as a Compact Disk (CD) or a Digital Versatile Disk (DVD), a persistent or non-persistent solid-state memory (e.g., Flash memory, Magnetic RAM, etc.), or any other suitable storage media. Such a computer-readable medium can be implemented in any suitable manner, including as system memory 426, accelerator memory 438, and/or storage 446 of the computer system 400 of FIG. 4 or as a stand-alone, separate storage medium. As used herein, “computer-readable media” (also called “computer-readable storage media”) refers to tangible storage media. Tangible storage media are non-transitory and have at least one physical, structural component. In a “computer-readable medium,” as used herein, at least one physical, structural component has at least one physical property that can be altered in some way during a process of creating the medium with embedded information, a process of recording information thereon, or any other process of encoding the medium with information. For example, a magnetization state of a portion of a physical structure of a computer-readable medium can be altered during a recording process.

Further, some techniques described above comprise acts of storing information (e.g., data and/or instructions) in certain ways for use by these techniques. In some implementations of these techniques-such as implementations where the techniques are implemented as computer-executable instructions-the information can be encoded on a computer-readable storage media. Where specific structures are described herein as advantageous formats in which to store this information, these structures can be used to impart a physical organization of the information when encoded on the storage medium. These advantageous structures can then provide functionality to the storage medium by affecting operations of one or more processors interacting with the information; for example, by increasing the efficiency of computer operations performed by the processor(s).

In some, but not all, implementations in which the techniques can be embodied as computer-executable instructions, these instructions can be executed on one or more suitable computing device(s) operating in any suitable computer system, or one or more computing devices (or one or more processors of one or more computing devices) can be programmed to execute the computer-executable instructions. A computing device or processor can be programmed to execute instructions when the instructions are stored in a manner accessible to the computing device/processor, such as in a local memory (e.g., an on-chip cache or instruction register, a computer-readable storage medium accessible via a bus, a computer-readable storage medium accessible via one or more networks and accessible by the device/processor, etc.). Functional facilities that comprise these computer-executable instructions can be integrated with and direct the operation of a single multi-purpose programmable digital computer apparatus, a coordinated system of two or more multi-purpose computer apparatuses sharing processing power and jointly carrying out the techniques described herein, a single computer apparatus or coordinated system of computer apparatuses (co-located or geographically distributed) dedicated to executing the techniques described herein, one or more Field-Programmable Gate Arrays (FPGAs) for carrying out the techniques described herein, or any other suitable system.

Embodiments have been described where the techniques are implemented in circuitry and/or computer-executable instructions. It should be appreciated that some embodiments can be in the form of a method, of which at least one example has been provided. The acts performed as part of the method can be ordered in any suitable way. Accordingly, embodiments can be constructed in which acts are performed in an order different than illustrated, which can include performing some acts simultaneously, even though shown as sequential acts in illustrative embodiments.

Various aspects of the embodiments described above can be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment can be combined in any manner with aspects described in other embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” “having,” “containing,” “involving,” and variations thereof herein, is meant to encompass the items listed thereafter and equivalents thereof as well as additional items.

The word “exemplary” is used herein to mean serving as an example, instance, or illustration. Any embodiment, implementation, process, feature, etc. described herein as exemplary should therefore be understood to be an illustrative example and should not be understood to be a preferred or advantageous example unless otherwise indicated.

The phrase “and/or,” as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements can optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

Unless otherwise noted, the terms “connected to” and “coupled to” (and their derivatives), as used in the specification and claims, are to be construed as permitting both direct and indirect (i.e., via other elements or components) connection.

Unless otherwise noted, a first numeric value is “approximately” equal to a second numeric value if the first numeric value is within ±20%, ±10%, or ±5% of the second numeric value.

Having thus described several aspects of at least one embodiment, it is to be appreciated that various alterations, modifications, and improvements will readily occur to those skilled in the art. Such alterations, modifications, and improvements are intended to be part of this disclosure, and are intended to be within the spirit and scope of the principles described herein. Accordingly, the foregoing description and drawings are by way of example only.

1. A computer system comprising:
one or more integrated circuits; and
a voltage regulator assembly including a power stage chip and an inductive component coupled to the power stage chip,
wherein a footprint of the power stage chip is bonded to a surface of a printed circuit board,
wherein the inductive component includes at least one coil, and wherein a first portion of the coil is disposed on or over a surface of the power stage chip,
wherein the printed circuit board, the power stage chip, and the first portion of the coil are arranged in a stack,
wherein the voltage regulator assembly is configured to provide a power supply signal to at least one integrated circuit of the one or more integrated circuits via the inductive component.

2. The computer system of claim 1, wherein a structure of the inductive component is asymmetric.

3. The computer system of claim 2, wherein a second portion of the coil is bonded to the first surface of the printed circuit board and situated laterally on the printed circuit board with respect to the power stage chip.

4. The computer system of claim 2, wherein the power stage chip is a first power stage chip, wherein the voltage regulator assembly further includes a second power stage chip, and wherein a footprint of the second power stage chip is bonded to a second surface of the printed circuit board opposite the first surface.

5. The computer system of claim 4, wherein the footprint of the second power stage chip is configured as a mirror reflection of the footprint of the first power stage chip.

6. The computer system of claim 4, wherein the first portion of the coil is configured to provide a thermal path for at least some heat dissipated by the first and second power stage chips.

7. The computer system of claim 4, wherein the voltage regulator assembly further includes a thermal pad disposed on or over the first power stage chip and a heat sink disposed on or over the thermal pad.

8. The computer system of claim 1, wherein the power supply signal is a first power supply signal, and wherein the power stage chip is configured to control an amount of power transferred from a second power supply signal to the first power supply signal by the voltage regulator assembly.

9. A voltage regulator assembly comprising:
a power stage chip; and
an inductive component coupled to the power stage chip,
wherein a footprint of the power stage chip is bonded to a surface of a printed circuit board,
wherein the inductive component includes at least one coil, and wherein a first portion of the coil is disposed on or over a surface of the power stage chip,
wherein the printed circuit board, the power stage chip, and the first portion of the coil are arranged in a stack, and
wherein the voltage regulator assembly is configured to provide one or more power supply signals via the inductive component.

10. The voltage regulator assembly of claim 9, wherein a structure of the inductive component is asymmetric.

11. The voltage regulator assembly of claim 10, wherein a second portion of the coil is bonded to the first surface of the printed circuit board and situated laterally on the printed circuit board with respect to the power stage chip.

12. The voltage regulator assembly of claim 10, wherein the power stage chip is a first power stage chip, wherein the voltage regulator assembly further includes a second power stage chip, and wherein a footprint of the second power stage chip is bonded to a second surface of the printed circuit board opposite the first surface.

13. The voltage regulator assembly of claim 12, wherein the footprint of the second power stage chip is configured as a mirror reflection of the footprint of the first power stage chip.

14. The voltage regulator assembly of claim 12, wherein the first portion of the coil is configured to provide a thermal path for at least some heat dissipated by the first and second power stage chips.

15. The voltage regulator assembly of claim 14, wherein the voltage regulator assembly further includes a thermal pad disposed on or over the first power stage chip and a heat sink disposed on or over the thermal pad.

16. A method of assembling a voltage regulator assembly, the method comprising:
bonding a footprint of a power stage chip to a surface of a printed circuit board;
situating an inductive component on or over the surface of the printed circuit board, wherein a first portion of a coil of the inductive component is disposed on or over a surface of the power stage chip; and
coupling a switch node of the power stage chip to the inductive component,
wherein the printed circuit board, the power stage chip, and the first portion of the coil are arranged in a stack, and
wherein the voltage regulator assembly is configured to provide one or more power supply signals via the inductive component.

17. The method of claim 16, wherein the power stage chip is a first power stage chip, the method further comprising bonding a footprint of a second power stage chip to a second surface of the printed circuit board opposite the first surface, wherein the first power stage chip, the second power stage chip, and a printed circuit board are arranged in a stack.

18. The method of claim 17, further including:
coupling one or more first contacts of the footprint of the first power stage chip to one or more respective second contacts of the footprint of the second power stage chip through one or more respective through via of the printed circuit board.

19. The method of claim 17, further including:
prior to the bonding of the footprint of the second power stage chip to the second surface of the printed circuit board, orienting the second power stage chip such that the footprint of the second power stage chip is configured as a mirror reflection of the footprint of the first power stage chip.

20. The method of claim 17, wherein the switch node of the second power stage chip is coupled to the inductive component through a through via of the printed circuit board and through a contact of the first power stage chip.
